(19) United States
(12) Patent Application Publication
(10) Pub. No.: US 2026/0064854 A1
(43) Pub. Date: Mar. 5, 2026

(54) Adaptive monitoring of operational technology networks

(71) Applicant: Tautuk, Inc., Jasper, GA (US)

(72) Inventors: Erik Nilsen, Anchorage, AK (US); Lee Krause, Indialantic, FL (US); Harold Moss, III, Peabody, MA (US)

(21) Appl. No.: 19/311,380

(22) Filed: Aug. 27, 2025

Related U.S. Application Data
(60) Provisional application No. 63/687,485, filed on Aug. 27, 2024.

(51) Int. Cl. G06F 21/57

(52) U.S. Cl. CPC G06F 21/577

(57) ABSTRACT

Embodiments include systems and methods for adaptive monitoring of operational technology networks. In some embodiments, the method includes collecting multi-modal time series data from a plurality of wireless sensor nodes deployed near at least one operational technology asset, aligning and fusing the time series data using dynamic time warping, extracting at least one feature and at least one dependency from the fused time series data, generating, based on the extracted feature and dependency, a real-time anomaly score using a trained machine learning model, determining, based on the real-time anomaly score, at least one anomaly regarding the operational technology asset, and presenting a visualization of the anomaly at an interactive user interface.

### CROSS REFERENCE TO RELATED APPLICATIONS

The present application claims the benefit of and priority to co-pending U.S. provisional application No. 63/687,485, filed on Aug. 27, 2024, the content of which is hereby incorporated by reference as if set forth in its entirety.

### TECHNICAL FIELD

Embodiments described herein relate generally to adaptive monitoring of cybersecurity and operational technology (OT) networks, and more specifically to adaptive real-time detection of anomalies and novelties at operational technology assets using multi-modal sensor nodes and machine learning techniques.

### BACKGROUND

Operational technology (OT) networks, such as networks controlling industrial processes and critical infrastructure, face increasingly sophisticated cyber-physical threats that traditional monitoring approaches fail to detect effectively. Modern industrial facilities can contain thousands of networked devices including programmable logic controllers (PLCs), supervisory control and data acquisition (SCADA) systems, distributed control systems (DCS), and industrial IoT devices, creating an expansive attack surface.

The convergence of information technology (IT) and OT systems, while enabling advanced automation and efficiency gains, has exposed previously isolated industrial control systems to cyber threats. Unlike traditional IT environments where security focuses primarily on data confidentiality, OT security often prioritizes system availability and safety, as disruptions can cause physical damage, environmental harm, or threats to human life. The unique characteristics of OT environments, including proprietary protocols, legacy systems with decades-long lifecycles, real-time operational constraints, and limited computational resources for security functions, necessitate specialized monitoring approaches.

Existing anomaly detection approaches for OT systems, however, suffer from fundamental limitations that can leave critical infrastructure vulnerable to sophisticated attacks. Network-based intrusion detection systems (NIDS) can monitor communication patterns but miss attacks that exploit legitimate protocols or occur through non-network vectors such as USB devices or insider threats. These systems typically employ signature-based detection requiring prior knowledge of attack patterns, rendering them ineffective against zero-day exploits and novel attack techniques.

Host-based monitoring solutions face deployment challenges in OT environments where installing agents on legacy systems may void warranties, cause stability issues, or violate safety certifications. Furthermore, the computational overhead of traditional security software can interfere with real-time control loops where microsecond-level timing precision is critical. Even lightweight monitoring agents can introduce latencies exceeding acceptable thresholds for safety-critical applications.

Physical process monitoring using existing SCADA systems provides some anomaly detection capability but remains limited by several factors. SCADA systems typically monitor only a subset of process variables deemed critical for control, missing subtle indicators of compromise detectable through broader sensor coverage. The sampling rates of traditional industrial sensors, often in the range of 1 to 10 Hz, are insufficient to capture high-frequency anomalies indicative of certain attack types. Additionally, SCADA data represents the logical view of the system, which sophisticated attackers can manipulate to hide malicious activities.

Existing machine learning approaches face practical deployment challenges. Supervised learning methods require labeled attack data that is scarce for OT environments and may not represent future attack variations. Unsupervised methods often generate excessive false positives due to the natural variability in industrial processes, leading to alert fatigue and reduced operator trust. Even state-of-the-art machine learning approaches can have false positives far exceeding levels necessary for practical deployment in 24/7 operations.

Existing multi-sensor fusion approaches for industrial monitoring often focus on equipment condition monitoring and predictive maintenance rather than security applications. These systems lack the sophisticated spatiotemporal analysis capabilities necessary to distinguish between legitimate operational changes and malicious manipulations. Furthermore, they typically operate on fixed sensor configurations without the adaptability to respond to evolving threat landscapes.

Therefore, a need exists for improved OT monitoring systems configured to detect cyber-physical threats through comprehensive environmental sensing and intelligent analysis.

### SUMMARY OF THE INVENTION

This summary is provided to introduce a selection of concepts in a simplified form that are further described below in the Detailed Description section. This summary is not intended to identify or exclude key features or essential features of the claimed subject matter, nor is it intended to be used as an aid in determining the scope of the claimed subject matter.

In one aspect, the techniques described herein relate to a computer-implemented method for adaptive monitoring of an operational technology network, including: collecting multi-modal time series data from a plurality of wireless sensor nodes deployed near at least one operational technology asset; aligning the time series data using dynamic time warping; extracting at least one feature from the aligned time series data; generating, based on the extracted feature, a real-time anomaly score using a trained machine learning model; determining, based on the real-time anomaly score, at least one anomaly regarding the operational technology asset; and presenting a visualization of the anomaly at an interactive user interface.

In some embodiments, the operational technology asset includes at least one of a manufacturing facility, a data center, or a chemical plant.

In some embodiments, the wireless sensor nodes include a plurality of sensing modalities, the modalities including at least two of an electromagnetic field sensor, an acoustic sensor, an accelerometer, an optical sensor, or a thermal sensor.

In some embodiments, the wireless sensor nodes are deployed to provide maximum coverage for monitoring the operational technology asset.

In some embodiments, the aligning of the time series data includes minimizing a total distance along a warping path.

In some embodiments, the feature and dependency are extracted using lagged correlation and Granger causality analysis.

In some embodiments, the machine learning model includes a convolutional LSTM neural network trained using historical time series data collected under normal operating conditions.

In some embodiments, the neural network includes an input layer, at least one graph convolutional layer fed by the input layer, at least one convolutional LSTM layer fed by the graph convolutional layer, and an output layer fed by the convolutional LSTM layer.

In some embodiments, the machine learning model is trained to capture spatial and temporal dependencies from input data.

In some embodiments, the visualization of the anomaly includes an interactive 3D model of the operational technology asset.

In some embodiments, the techniques described herein relate to a computer-implemented method, further including: receiving, at the user interface, a selection of the anomaly; generating a description of the anomaly, the description including at least one recommended action for the anomaly; and presenting the description at the user interface.

In some embodiments, the techniques described herein relate to a computer-implemented method, further including fusing the extracted feature, wherein the trained learning model receives the fused feature as input.

In some embodiments, the determining of the anomaly includes comparing the anomaly score to an adaptive threshold value using a sliding window.

In another aspect, the techniques described herein relate to a system for adaptive monitoring of operational technology networks, including: a plurality of wireless sensor nodes for collecting multi-modal time series data, the sensor nodes deployed near at least one operational technology asset; memory storing instructions; and at least one processor executing the instructions to perform the steps of: aligning the time series data using dynamic time warping; extracting at least one feature from the aligned time series data; generating, based on the extracted feature, a real-time anomaly score using a trained machine learning model; determining, based on the real-time anomaly score, at least one anomaly regarding the operational technology asset; and presenting a visualization of the anomaly at an interactive user interface.

In some embodiments, the operational technology asset includes at least one of a manufacturing facility, a data center, or a chemical plant.

In some embodiments, the wireless sensor nodes include a plurality of sensing modalities, the modalities including at least two of an electromagnetic field sensor, an acoustic sensor, an accelerometer, an optical sensor, or a thermal sensor.

In some embodiments, the feature and dependency are extracted using lagged correlation and Granger causality analysis.

In some embodiments, the machine learning model includes a convolutional LSTM neural network trained using historical time series data collected under normal operating conditions.

In some embodiments, the visualization of the anomaly includes an interactive 3D model of the operational technology asset.

In yet another aspect, the techniques described herein relate to a computer program product embodied in a non-transitory computer readable storage medium and including computer instructions for: collecting multi-modal time series data from a plurality of wireless sensor nodes deployed near at least one operational technology asset; aligning the time series data using dynamic time warping; extracting at least one feature from the aligned time series data; generating, based on the extracted feature, a real-time anomaly score using a trained machine learning model; determining, based on the real-time anomaly score, at least one anomaly regarding the operational technology asset; and presenting a visualization of the anomaly at an interactive user interface.

### BRIEF DESCRIPTION OF DRAWINGS

Non-limiting and non-exhaustive embodiments of the invention are described with reference to the following figures, wherein like reference numerals refer to like parts throughout the various views unless otherwise specified.

FIG. 1 illustrates a monitoring system for adaptive monitoring of operational technology networks in accordance with one embodiment.

FIG. 2 illustrates a sensor node for adaptive monitoring of operational technology networks in accordance with one embodiment.

FIG. 3 illustrates a ConvGLSTM neural network architecture in accordance with one embodiment.

FIG. 4 illustrates a signal processing pipeline for handling stationary and non-stationary industrial signals in accordance with one embodiment.

FIG. 5 illustrates a three-dimensional sensor deployment strategy within an industrial facility in accordance with one embodiment.

FIG. 6 illustrates a flowchart of a method for adaptive monitoring of operational technology networks in accordance with one embodiment.

FIG. 7 illustrates a multi-modal sensor fusion architecture in accordance with one embodiment.

FIG. 8 illustrates a real-time monitoring interface in accordance with one embodiment.

FIG. 9 illustrates a flowchart of another method for adaptive monitoring of operational technology networks in accordance with one embodiment.

### DEFINITIONS

Unless otherwise specified, the following terms as used herein shall have the meanings as provided below:

The term “adaptive threshold” refers to a dynamic anomaly detection threshold that can automatically adjust. In some embodiments, the threshold may adjust based on operational patterns using statistical methods such as sliding window analysis, exponential smoothing, or Kalman filtering.

The term “anomaly score” refers to a numerical measure indicating the degree to which current sensor observations deviate from learned normal patterns. In some embodiments, the anomaly score may be computed as a reconstruction error, a likelihood under the learned distribution, and/or a distance in feature space, with higher scores indicating greater abnormality.

The term “ConvGLSTM” (Convolutional Graph Long Short-Term Memory) denotes a novel neural network architecture combining graph convolutional layers for spatial feature learning with LSTM layers for temporal sequence modeling.

The term “cyber-physical attack” refers to malicious activities targeting assets such as industrial control systems with intent to manipulate physical processes, including but not limited to false data injection, command injection, denial of service, and manipulation of safety systems.

The term “dynamic time warping” (DTW) refers to an algorithm for measuring similarity between temporal sequences that may vary in speed or phase. In some embodiments, the algorithm may find optimal alignment by minimizing cumulative distance along a warping path.

The term “edge computing device” means a computational unit deployed near sensor nodes providing local processing capabilities including data aggregation, preprocessing, preliminary anomaly detection, and buffering, reducing bandwidth requirements and enabling real-time response.

The term “false positive rate” (FPR) refers to a rate that indicates the proportion of normal operational states incorrectly classified as anomalies.

The term “granger causality” refers to a statistical concept determining whether past values of one time series contain information useful for predicting another series beyond what is contained in its own past.

The term “multi-modal sensing” refers to the simultaneous use of multiple sensor types measuring different physical phenomena. In some embodiments, the multi-modal sensing may provide complementary information that enables more robust anomaly detection than any single modality.

The term “stationary signal” refers to a time series whose statistical properties remain constant over time.

The term “non-stationary signal” refers to a time series whose statistical properties (mean, variance, autocorrelation) change over time.

The term “operational Technology” (OT) refers to any hardware and software system that monitor and control physical devices, processes, and events in industrial environments.

The term “spatiotemporal feature” refers to a data representation capturing both spatial relationships and temporal patterns in data measurements.

The term “true positive rate” (TPR) or sensitivity refers to a rate that measures the proportion of actual anomalies correctly identified by a system.

The term “zero-day attack” refers to a previously unknown attack exploiting undisclosed vulnerabilities. The zero-day attack may be undetectable by signature-based methods and require behavior-based anomaly detection approaches.

### DETAILED DESCRIPTION

Embodiments described herein include adaptive monitoring systems and methods for detecting anomalies and novelties at operational technology networks through spatiotemporal analysis of data from multi-modal sensors. Some embodiments include a novel architecture combining distributed multi-modal sensing, advanced signal processing for stationary and non-stationary data, and deep learning models specifically designed for spatiotemporal anomaly detection in OT environments.

The described embodiments may address limitations of existing OT security solutions by combining sensing coverage, signal processing for industrial environments, and machine learning for reducing false positives while increasing true positive detection rates. Some embodiments may provide benefits such as coverage of the cyber-physical attack surface through diverse sensing modalities, maintaining low false positive rates suitable for continuous operation, detecting anomalies indicative of attacks or early-stage failures, adapt to legitimate operational changes while maintaining sensitivity to threats, operating non-intrusively without affecting control systems, and scaling to complex industrial facilities with thousands of monitored points.

### System Architecture Overview

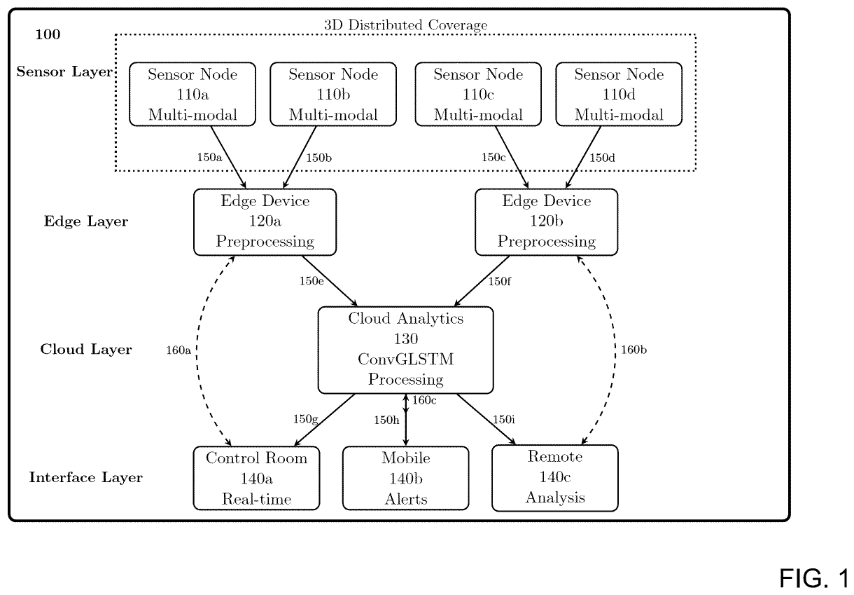

FIG. 1 illustrates a monitoring system 100 for adaptive monitoring of operational technology networks. Unlike conventional approaches that rely on network traffic analysis or limited process variable monitoring, the system 100 may create a dense, three-dimensional sensing mesh throughout an industrial facility, capturing environmental changes that may indicate security breaches, equipment malfunctions, and/or safety hazards.

The system 100 may comprise four hierarchical layers working in concert: distributed multi-modal sensor nodes 110 providing environmental awareness, edge computing devices 120 performing real-time preprocessing and preliminary analysis, a cloud-based analytics platform 130 executing machine learning algorithms (e.g., ConvGLSTM algorithms), and intuitive operator interfaces 140 (e.g., control room displays, mobile alerts, remote analysis stations, etc.) enabling rapid threat assessment and response.

FIG. 1 shows data flow paths 150 for enabling sensor data transmission and control feedback loops 160 facilitating real-time anomaly detection and coordinated response across the entire operational technology infrastructure within the boundary of the system 100. The sensor nodes 110 may capture multi-modal environmental data and transmit the data via data flows paths 150 a to 150 d to edge computing devices 120 for preliminary processing. The edge computing devices 120 may forward processed data via data flow paths 150 e and 150 f to cloud analytics platform 130 running ConvGLSTM algorithms. The results may flow via data flow paths 150 a to 150 i to operator interfaces 140 including a control room 140 a, mobile alerts 140 b, and remote analysis stations 140 c. The control feedback loops 160 may enable real-time system adaptation and coordinated threat response.

The sensor nodes 110 may form the sensory foundation of the system 100, with each sensor node 110 containing multiple sensing modalities carefully selected to provide complementary threat detection capabilities. A typical deployment in a medium-sized industrial facility may include 50 to 200 sensor nodes, with density determined by factors including facility size and complexity, criticality of monitored assets, environmental conditions affecting signal propagation, and/or required spatial resolution for anomaly localization. Each sensor node 110 may operate autonomously, sampling environmental parameters at rates ranging from 1 Hz for slowly varying phenomena like temperature to 100 kHz for high-frequency electromagnetic emissions, with intelligent power management ensuring months of operation on battery power supplemented by energy harvesting. The collected sensor data may be transmitted via wireless protocols to the edge devices 120, remote platforms such as the analytics platform 130, and/or hybrid architectures depending on the specific deployment requirements and available infrastructure.

The edge computing devices 120 may aggregate data from multiple sensor nodes and perform various preprocessing tasks, such as reducing data volume, statistical normalization, stationarity testing, and/or extracting relevant features. The devices 120 may perform the preprocessing tasks before transmission to the analytics platform 130 (and/or any other remote system). The devices 120 may perform more time-critical tasks and relay more computationally intensive tasks (e.g., model inferences using ConvGLSTM algorithms) to the analytics platform 130. The devices 120 may include any suitable edge device, such as industrial embedded computers, industrial gateways, and/or edge servers. The devices 120 may include processing units for executing instructions stored in memory. The devices 120 may execute lightweight anomaly detection algorithms enabling sub-second response to critical events without cloud connectivity dependence. This hierarchical processing architecture may balance real-time responsiveness with sophisticated analysis capabilities, addressing the unique latency and reliability requirements of OT environments where network connectivity may be intermittent or bandwidth-constrained.

The analytics platform 130 may perform various centralized, high-capacity processing tasks for the monitoring system 100. The analytics platform 130 may be deployed on a public cloud infrastructure (e.g., AWS, Microsoft Azure, Google Cloud Platform, etc.), a private enterprise cloud, and/or a hybrid configuration combining both. The analytics platform 130 may receive preprocessed data from the devices 120. The analytics platform 130 may aggregate the data across multiple sites for cross-facility analysis, anomaly detection, and/or centralized model training. The analytics platform 130 may execute models, such as models using ConvGLSTM architectures, to detect anomalies from the received data. The analytics platform 130 may train the models using historical data from past sensor measurements. The analytics platform 130 may include cloud storage to maintain a historical data repository and/or trained models.

The operator interfaces 140 may provide various interface and anomaly investigation tools. Each interface type (e.g., the control room 140 a, mobile alerts 140 b, and remote analysis stations 140 c) may provide visualizations of the detected anomalies. The visualizations may include representations of various aspects of the detected anomalies, such as 3D models of monitored assets.

Operators may perform various actions via the operator interfaces 140, such as increasing sensor sampling rates, reconfiguring detection thresholds, triggering mobile sensor deployment, and/or initiating automated facility lockdown protocols. The actions may be performed as part of the control feedback loops 160, which enable the monitoring system 100 to adapt in real-time to detected anomalies and/or feedback. For example, the operators may, using the operator interfaces 140, label a detected anomaly as a true positive or a false positive. The label may be transmitted to the devices 120 and/or the analytics platform 130 for reconfiguration.

### Multi-Modal Sensor Node Design and Implementation

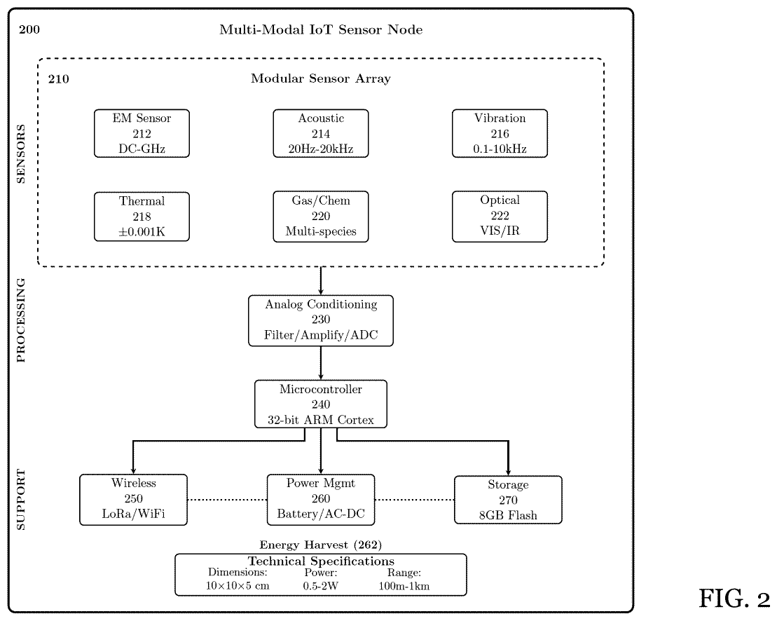

FIG. 2 illustrates a sensor node 200 for adaptive monitoring of operational technology networks. The sensor node 200 may be similar to any of the nodes described herein, such as the sensor nodes 110. The sensor node 200 may be a component of a monitoring system, such as the system 100.

The sensor node 200 may integrate diverse sensing capabilities within a compact, low-power platform suitable for widespread deployment. The modular architecture of the sensor node 200 may enable customization for specific monitoring requirements while maintaining standardized interfaces for seamless system integration. A sensor array 210 within the sensor node 200 may be designed to capture a comprehensive picture of the local environment, with individual sensors selected based on extensive analysis of threat vectors and failure modes in industrial settings. Power flexibility may be achieved through multiple options such as rechargeable lithium-ion batteries providing 6 to 12 months of autonomous operation, AC-DC power adapters for permanent installations with available mains power, Power-over-Ethernet (PoE) for locations with suitable network infrastructure, and/or supplementary energy harvesting from environmental sources.

The sensor array 210 may include any number of suitable sensor modalities. For example, the sensor node 200 may be a multi-modal sensor that includes multiple sensor modalities. As shown, the sensor array 210 may include an electromagnetic field sensor 212, an acoustic sensor 214, a vibration sensor 216, a thermal sensor 218, a gas and atmospheric composition sensor 220, and an optical sensor 222. Other exemplary sensor modalities may include radiation sensors for detecting radiation (e.g., at a nuclear facility), LIDAR sensors for monitoring environments using spatial maps, radio frequency (RF) sensors for detecting radio frequency signals (e.g., from electronic equipment), and/or biosensors for detecting biological hazards or pathogens. The sensor array 210 may include data buffers to preserve sensor data in the event of outages or other unexpected events.

The electromagnetic field sensor 212 may monitor a wide frequency spectrum from DC to several GHz, detecting anomalies ranging from power line disturbances indicative of equipment failures to unauthorized wireless transmissions suggesting cyber-attacks. For high-frequency signals in the MHz to GHz range, the sensor 212 may employ specialized detection techniques that avoid the need for impractical multi-GHz sampling rates. The techniques may include envelope detection circuits that extract the amplitude modulation of high-frequency carriers, heterodyne mixing that down-converts signals of interest to intermediate frequencies suitable for digitization, and/or energy detection across frequency bands using analog filters and power detectors. For example, detecting a 2.4 GHz WiFi signal does not require 5 GHz sampling. Instead, the sensor 212 may use a mixer with a 2.3 GHz local oscillator to produce a 100 MHz intermediate frequency that can be sampled at 250 MHz, or may use a power detector to measure the presence and strength of signals in the 2.4 GHz band.

The acoustic sensor 214 may capture sound signatures, such as signatures from below 20 Hz (infrasound) to above 20 kHz (ultrasound). Industrial equipment often generates characteristic acoustic signatures during normal operation, with deviations indicating problems like bearing wear, cavitation, or mechanical loosening. Acoustic monitoring may detect covert activities such as unauthorized equipment access, drilling or cutting sounds suggesting physical tampering, and/or ultrasonic communications used in some data exfiltration techniques. The monitoring system may employ advanced beamforming techniques using multiple distributed acoustic sensors to localize sound sources and separate overlapping signatures. The signal processing algorithms applied to acoustic data may be general and equally applicable to any sensor modality. That is, the same anomaly detection framework may process electromagnetic, vibration, thermal, and/or chemical sensor data with appropriate feature extraction for each modality.

The vibration sensor 216 may detect mechanical oscillations transmitted through structures. The vibration sensor 216 may be MEMS-based accelerometers and/or other suitable sensor types. The vibration sensor 216 may measure vibrations from sub-Hz frequencies indicative of building sway or seismic activity to several kHz representing high-speed machinery operation. The monitoring system may learn normal vibration patterns during training, including variations due to operational changes like equipment startup/shutdown sequences, load variations, and maintenance activities. Anomalies may indicate equipment imbalance, foundation settling, or deliberate attempts to access secured areas through walls or floors. The ConvGLSTM architecture may process vibration data using the same spatiotemporal analysis framework applied to all sensor modalities, demonstrating the generality of the approach.

The thermal sensor 218 may detect temperature variations that may indicate equipment overheating, fire hazards, and/or the presence of unauthorized electronic devices. The thermal sensor 218 may detect unauthorized devices by detecting their characteristic thermal emissions, which may differ from ambient conditions and/or from known authorized equipment profiles. The thermal sensor 218 may include single-point infrared thermometers, multi-point thermopile arrays, high-resolution thermal imaging cameras, and/or other suitable thermal sensing devices.

The monitoring system may employ point temperature measurements and/or thermal imaging arrays to create detailed thermal maps of monitored areas. During training, the monitoring system may learn normal thermal patterns including diurnal variations, heat generated by legitimate equipment operation, and thermal signatures of authorized personnel. Anomalies may include unexpected hot spots suggesting hidden computing devices used in cyber-attacks, cooling system failures threatening equipment integrity, and/or thermal signatures of unauthorized individuals in restricted areas.

The gas and atmospheric composition sensor 220 may monitor air quality parameters including oxygen, carbon dioxide, carbon monoxide, hydrogen sulfide, volatile organic compounds (VOCs), and/or particulate matter. The sensor 220 may contribute to security monitoring by detecting chemical signatures of overheating electronics, combustion products from fire or explosion, and/or unusual chemical releases potentially indicating sabotage. The monitoring system may learn normal atmospheric variations during different operational phases, distinguishing between expected changes like increased CO₂ during shift changes and anomalous conditions requiring investigation. For example, sudden spikes in particulate concentration combined with elevated temperatures may indicate combustion events or explosions, while detection of unexpected chemical signatures (e.g., solvents or toxic industrial chemicals in restricted zones) may indicate acts of sabotage or contamination.

The optical sensor 222 may span visible and near-infrared spectra and detect visual anomalies through both imaging and non-imaging techniques. Photodiode arrays may monitor ambient light levels and may detect unusual lighting patterns suggesting unauthorized access or equipment malfunction. More sophisticated implementations include low-resolution thermal cameras identifying heat signatures of people or equipment, and/or specialized sensors detecting optical emissions from electrical arcing or corona discharge. The monitoring system may process optical data to identify anomalies while respecting privacy requirements in facilities with human workers.

The sensor node 200 may include processing units for processing various tasks, such as the analog conditioning unit 230 and the microcontroller 240. The analog conditioning unit 230 may receive raw analog signals from the sensor array 210 and process the signals to be compatible with the microcontroller 240. The analog conditioning unit 230 may perform conditioning tasks such as amplification, filtering, impedance matching, linearization, and/or signal level shifting. The analog conditioning unit 230 may send conditioned data to the microcontroller 240 for further processing.

The microcontroller 240 may serve as the primary processing and control unit for the sensor node 200. The microcontroller 240 may perform various processing and control tasks, such as coordinating data acquisition with the analog conditioning unit 230, managing communications with support units, performing power management tasks, performing preprocessing tasks, and/or buffering and transmitting data to external systems such as the devices 120. For example, the microcontroller 240 may convert analog signals to digital signals, perform local digital signal processing (DSP) tasks on the sensor data prior to transmission such as fast Fourier transforms (FFT) or digital filtering (e.g., using low-pass, high-pass, band-pass, or adaptive filters), and/or perform statistical feature extraction.

The sensor node 200 may include support units for performing support functions, such as a wireless unit 250, a power management unit 260, and a storage unit 270. The microcontroller 240 may manage and communicate with the support units.

The wireless unit 250 may provide wireless communication channels between the sensor node 200 and remote systems or components, such as the devices 120 and/or the analytics platform 130. The wireless unit 250 may transmit sensor data to the remote systems or components.

The power management unit 260 may manage and monitor power sources for operating the sensor node 200. The power sources may include internal rechargeable or non-rechargeable batteries, external power lines, AC-DC power adaptors, and/or energy harvest sources (e.g., vibration, thermal gradients, solar cells, wind turbines, etc.).

The storage unit 270 may provide storage for the sensor node 200. The storage unit 270 may include non-volatile memory devices, such as flash memory, solid-state drives (SSDs), and/or embedded MultiMediaCard (eMMC) modules. The storage unit 270 may store data such as raw sensor data, processed data, operational metadata, and/or buffer data (e.g., before transmission using the wireless unit 250). The storage unit 270 may store instructions for execution by the processing units, such as the analog conditioning unit 230 and the microcontroller 240.

### ConvGLSTM Architecture

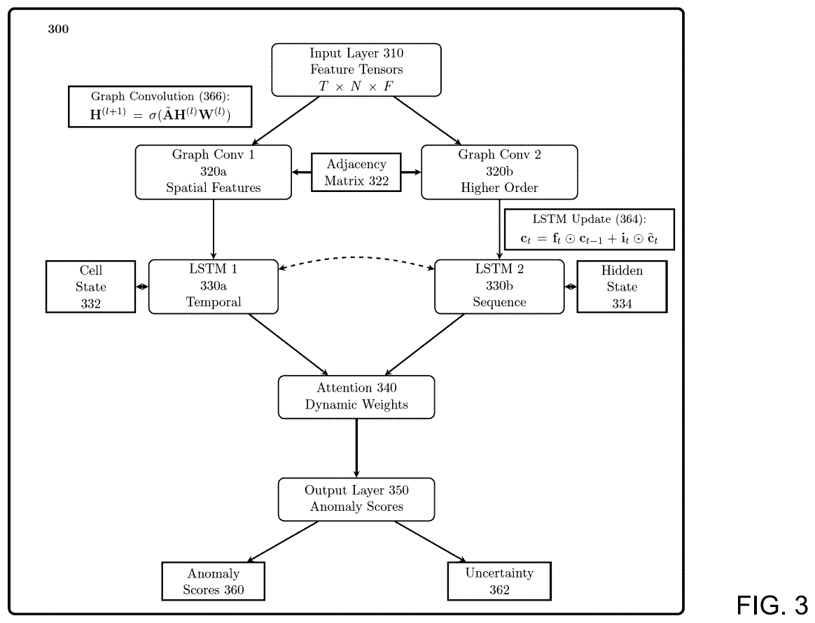

FIG. 3 illustrates a ConvGLSTM neural network architecture 300. Data may flow from an input layer 310 receiving preprocessed spatiotemporal feature tensors through graph convolutional layers 320 that utilize an adjacency matrix 322 to model sensor network topology. The data may continue through LSTM layers 330 that maintain cell states 332, hidden states 334 for temporal pattern recognition, and an attention mechanism 340 for dynamic feature weighting. The data flow may culminate at an output layer 350 that generates anomaly scores 360 with associated uncertainty estimates 362 for confident decision-making.

The architecture 300 may be designed to capture complex spatiotemporal patterns in distributed sensor networks. The architecture 300 may address limitations of existing approaches that either ignore spatial relationships by treating sensors independently or fail to capture temporal dynamics by analyzing only instantaneous snapshots. The architecture 300 may seamlessly integrate spatial and temporal processing, enabling detection of sophisticated anomalies manifesting as coordinated patterns across multiple sensors and time scales. The architecture 300 may process data from any sensor modality using the same fundamental framework, with only the input feature extraction adapted to each sensor type.

The input layer 310 may receive preprocessed spatiotemporal feature tensors [symbol] ∈ [symbol] ^{T×N×F}, where T represents the temporal dimension (sequence length), N is the number of sensor nodes, and F is the feature dimension for each node. These features may include raw sensor measurements and/or derived quantities like lagged correlations and Granger causality metrics. The tensor representation may preserve the rich structure of the sensor network data, enabling the model to learn complex dependencies. The same tensor format may accommodate data from electromagnetic sensors measuring field strengths, acoustic sensors capturing sound pressure levels, vibration sensors recording accelerations, and/or any other modality.

The graph convolutional layers 320 may process the spatial dimension, leveraging the sensor network topology encoded in adjacency matrix A∈ [symbol] ^{N×N}. The adjacency matrix 322 may capture relationships between sensors based on physical proximity, functional connections (e.g., sensors monitoring the same equipment), and/or learned dependencies from Granger causality analysis. Graph convolution operations may aggregate information from neighboring sensors:

$${H}^{( l + 1 )} = σ ( {\tilde{D}}^{- \frac{1}{2}} \tilde{A} {\tilde{D}}^{- \frac{1}{2}} {H}^{( l )} {W}^{( l )} ) \qquad ( 1 )$$

where Ã=A+I is the adjacency matrix with added self-connections, \tilde{D} is the corresponding degree matrix, w^{(l)} are learnable parameters, and σ is an activation function. This formulation may enable each sensor to aggregate information from its neighbors while preserving its own signal, learning spatial patterns indicative of anomalies regardless of the physical quantities being measured.

The graph convolutional layers 320 may be organized into one or more convolutional blocks, such as a block 320 a and a block 320 b. As shown, the block 320 a may process spatial features, such as feature extracted from thermal imagery, optical video frames, and/or spatially mapped environmental measurements. The block 320 b may process high order features, such as recurring composite patterns, long-period oscillation, and/or compound event sequences. The blocks 320 a and 320 b may operate in parallel and/or in sequence.

The LSTM layers 330 may process temporal sequences, maintaining the cell states 332 for capturing long-term dependencies and the hidden states 334 for representing short-term patterns. For each time step, the LSTM layers 330 may update their states through a series of gating mechanisms:

$${f}_{t} = σ ( {W}_{f} \cdot [ {h}_{t - 1} , {x}_{t} ] + {b}_{f} ) ( forget gate ) \qquad ( 2 )$$

$${i}_{t} = σ ( {W}_{i} \cdot [ {h}_{t - 1} , {x}_{t} ] + {b}_{i} ) ( input gate ) \qquad ( 3 )$$

$${\tilde{c}}_{t} = tanh ( {W}_{c} \cdot [ {h}_{t - 1} , {x}_{t} ] + {b}_{c} ) ( candidate values ) \qquad ( 4 )$$

$${c}_{t} = {f}_{t} ⊙ {c}_{t - 1} + {i}_{t} ⊙ {\tilde{c}}_{t} ( cell state ) \qquad ( 5 )$$

$${o}_{t} = σ ( {W}_{o} \cdot [ {h}_{t - 1} , {x}_{t} ] + {b}_{o} ) ( output gate ) \qquad ( 6 )$$

$${h}_{t} = {o}_{t} ⊙ tanh ( {c}_{t} ) ( hidden state ) \qquad ( 7 )$$

These mechanisms may enable the model to selectively remember relevant patterns, forget outdated information, and update its understanding based on new observations, which may be beneficial for adapting to evolving operational patterns while maintaining sensitivity to anomalies. The LSTM layers 330 may process temporal patterns similarly regardless of whether the patterns originate from temperature trends, vibration sequences, and/or electromagnetic fluctuations.

The LSTM layers may be organized into multiple LSTM blocks, such as a block 330 a and a block 330 b. As shown, the blocks 330 a and 330 b may process outputs from a corresponding convolutional block. For example, the block 330 a may process outputs from the block 320 a, and the block 330 b may process outputs from the block 320 b.

The attention mechanism 340 may dynamically weight different sensors and time steps based on their relevance to anomaly detection. This may address the challenge that not all sensors contribute equally to detecting specific anomaly types. For example, electromagnetic sensors may be most relevant for detecting wireless attacks, while vibration sensors may be most relevant for mechanical failures. The attention weights may be computed as:

$${α}_{i , t} = \frac{exp ( {e}_{i . t} )}{{\sum }_{j , τ} exp ( {e}_{i . τ} )} \qquad ( 8 )$$

where e_{i,t}=v^{T} tanh(Wₕh_{i,t}+b) represents the attention score for sensor i at time t. This mechanism may enable the model to focus on the most informative signals while maintaining global awareness, automatically adapting to the most relevant modalities for each situation.

The output layer 350 may generate anomaly scores 360 indicating the degree of abnormality in current observations. The anomaly scores 360 may be binary classifications and/or continuous scores that enable nuanced decision-making and priority-based response. The architecture 300 may generate uncertainty estimates 362 using techniques like Monte Carlo dropout or ensemble methods, quantifying confidence in its predictions. High uncertainty may indicate novel situations requiring human expert review, while high-confidence anomalies may trigger automated responses. These outputs may be generated through the same process regardless of the input sensor modalities.

### Training Methodology for Comprehensive Normal Behavior Learning

The effectiveness of the monitoring system may depend on comprehensive training that captures the full spectrum of normal operational patterns. The monitoring system may use a sophisticated training methodology addressing the challenge that normal behavior in industrial settings encompasses substantial variability due to different operating modes, product changeovers, maintenance activities, seasonal variations, and/or gradual equipment degradation. Insufficient training data may lead to excessive false positives as legitimate operational variations are flagged as anomalies. The training process may remain consistent across all sensor modalities, with the monitoring system automatically adapting to the specific characteristics of each data type.

The training process may begin with a data collection phase. The phase may last 2 to 4 weeks for complex facilities, though this duration may be extended for operations with longer cyclic patterns. During this period, the monitoring system may operate in a learning mode, collecting sensor data while facility operators log all significant events including production schedule changes, maintenance activities, environmental conditions, and/or any unusual but authorized operations. This contextual information may be beneficial for understanding detected patterns and setting appropriate anomaly thresholds. The collected data streams from all sensor modalities (e.g., electromagnetic, acoustic, vibration, thermal, chemical, optical, etc.) may be processed through the same training pipeline, with modality-specific feature extraction as the only differentiation.

The monitoring system may use several techniques to ensure comprehensive coverage of normal behavior space. Data augmentation may generate synthetic variations of collected patterns, expanding the training set to include plausible scenarios not observed during collection. For example, if temperature sensors show diurnal variations of ±5° C., augmentation might generate patterns with ±7° C. variations to provide robustness against seasonal changes. Transfer learning may leverage pre-trained models from similar facilities, accelerating convergence while maintaining facility-specific adaptation. Active learning may identify regions of uncertainty where additional training data would be most valuable, guiding operators to perform specific operational scenarios during extended training phases. These techniques may apply uniformly to all sensor data types.

The cell phone detection example illustrates the importance of context-aware training. In facilities prohibiting mobile phones, any cellular frequency detection may represent an anomaly. However, the monitoring system may be configured to distinguish between security threats and benign violations. During training, controlled experiments may introduce phones at various locations and times, teaching the monitoring system that brief detections near entrances during shift changes likely represent workers forgetting to leave phones in lockers, while sustained signals from production areas indicate serious violations. The monitoring system may learn not just to detect cellular frequencies but to interpret them contextually based on location, duration, time of day, and/or correlation with other sensors (e.g., door access logs). This contextual learning framework may apply equally to any sensor modality, such as learning which vibration patterns indicate normal maintenance versus equipment failure.

For facilities allowing phones, training may become more nuanced. The monitoring system may learn normal usage patterns. For example, phones typically remain relatively stationary at workstations, show periodic brief activations for checking messages, and exhibit characteristic frequency patterns for different carriers and phone models. Anomalous behaviors may include phones moving through restricted areas, unusual data transmission patterns suggesting exfiltration, and/or jamming signals attempting to disrupt legitimate communications. The monitoring system may learn these distinctions through extended training encompassing various legitimate use cases while security teams perform controlled penetration tests to generate labeled anomaly examples.

The training process may continuously validate model performance using techniques like k-fold cross-validation on historical data and real-time shadow mode operation where the model generates predictions compared against expert annotations. Performance metrics tracked may include true positive rate (i.e., sensitivity), false positive rate (calculated as 1—specificity), precision (i.e., positive predictive value), F₁ score balancing precision and recall, and/or area under the ROC curve (AUC) for threshold-independent assessment. The monitoring system may require false positive rates below 0.1% before transitioning to operational deployment, ensuring operator trust and preventing alert fatigue. These performance criteria may apply uniformly regardless of the sensor modalities involved.

### Advanced Signal Processing for Complex Industrial Environments

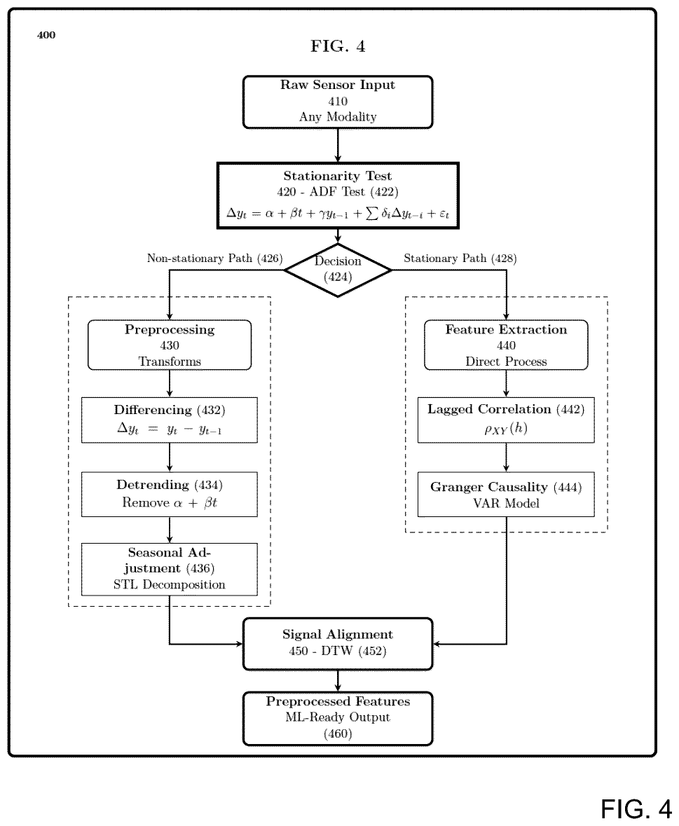

FIG. 4 illustrates a signal processing pipeline 400 designed to handle both stationary and non-stationary industrial signals, beginning with raw sensor input 410 flowing to a stationarity testing module 420 employing an Augmented Dickey-Fuller (ADF) test 422. Based on test results, signals may undergo conditional preprocessing 430 with options for differencing 432, detrending 434, or seasonal adjustment 436. The pipeline 400 may continue through feature extraction 440, lagged correlation analysis 442 and Granger causality analysis 444, concluding with signal alignment 450 utilizing dynamic time warping 452 to synchronize multi-rate sensor data. The pipeline 400 may output preprocessed features that may be provided to a model as input, such as a model implemented by the architecture 300.

The pipeline 400 may be designed to handle the characteristics of real-world industrial sensor data. Industrial environments may generate signals combining deterministic components from equipment operation, stochastic variations from turbulent processes, periodic patterns from rotating machinery, transient events from operational changes, and/or various noise sources from electromagnetic interference to mechanical vibrations. Traditional anomaly detection systems often fail when confronted with such complexity, generating false positives that render them practically useless. The signal processing techniques described here may be applicable across all sensor modalities regardless of whether the techniques process electromagnetic, acoustic, vibration, thermal, and/or chemical sensor data.

The pipeline 400 may begin by assessing the stationarity of each sensor signal using the ADF test 422. For a time series {yₜ}, the ADF test may fit the regression model:

$$Δ {y}_{t} = α + β t + γ {y}_{t - 1} + {{\sum }_{i = 1}}^{p} {δ}_{i} Δ {y}_{t - i} + {ε}_{t} \qquad ( 9 )$$

where Δyₜ=yₜ−yₜ₋₁ represents the first difference, α captures any drift, βt models deterministic trends, p is the lag order selected using information criteria, and εₜ is white noise. The null hypothesis of non-stationarity (γ=0) may be tested against the alternative of stationarity (γ<0). This automated classification may enable appropriate preprocessing for each signal type, dramatically improving subsequent analysis accuracy regardless of the sensor modality producing the signal.

For non-stationary signals, the pipeline 400 may apply conditional preprocessing 430 to achieve stationarity. Differencing 432 may remove stochastic trends by computing Δyₜ=yₜ−yₜ₋₁, effective for signals with unit roots. Detrending 434 may fit and remove deterministic trends using techniques ranging from simple linear regression to sophisticated wavelet decomposition. Seasonal adjustment 436 may identify and remove periodic components using methods like STL (Seasonal and Trend decomposition using Loess) or X-13ARIMA-SEATS, which may be important for signals influenced by diurnal cycles, weekly production schedules, and/or seasonal variations. These preprocessing steps may be applied uniformly to any time series data regardless of its physical origin.

Following stationarity transformation, the pipeline 400 may extract rich features capturing both individual signal characteristics and inter-sensor relationships. The lagged correlation analysis 442 may compute the cross-correlation function between sensor pairs at various time delays:

$${ρ}_{XY} ( h ) = \frac{{γ}_{XY} ( h )}{\sqrt{{γ}_{XX} ( 0 ) {γ}_{YY} ( 0 )}} \qquad ( 10 )$$

where γ_{XY}(h)=E[(Xₜ₊ₕ−μ_{X})(Yₜ−μ_{Y})] is the cross-covariance at lag h. This may reveal how disturbances propagate through the facility. For instance, a mechanical failure may cause vibrations that are detected immediately by nearby sensors but reach distant sensors after a delay corresponding to wave propagation through the structure. This analysis may apply equally to correlations between any sensor types, such as temperature changes preceding pressure variations or electromagnetic anomalies coinciding with unusual network traffic.

The granger causality analysis 444 may go beyond correlation to identify directional influences between sensors. The pipeline 400 may fit vector autoregressive (VAR) models:

$${X}_{t} = {{\sum }_{k = 1}}^{p} {A}_{xx , k} {X}_{t - k} + {{\sum }_{k = 1}}^{p} {A}_{xy , k} {Y}_{t - k} + {ε}_{x , t} \qquad ( 11 )$$

$${Y}_{t} = {{\sum }_{k = 1}}^{p} {A}_{yx , k} {X}_{t - k} + {{\sum }_{k = 1}}^{p} {A}_{yy , k} {Y}_{t - k} + {ε}_{y , t} \qquad ( 12 )$$

Testing whether coefficients A_{xy,k} are jointly zero may determine if Y Granger-causes X. This analysis may construct a directed graph of sensor influences, which may be beneficial for root cause analysis when anomalies are detected. The mathematical framework may remain identical regardless of whether the framework analyzes electromagnetic-acoustic relationships, thermal-vibration dependencies, and/or any other cross-modal interactions.

The dynamic time warping 452 may address synchronization challenges when comparing signals with different sampling rates or temporal variations. The DTW algorithm may find an optimal alignment between sequences by solving:

$$DTW ( X , Y ) = {min}_{π} \sqrt{{\sum }_{( i , j ) ∈ π} {d ( {x}_{i ,} {y}_{j} )}^{2}} \qquad ( 13 )$$

where π represents the warping path and d(xᵢ, yⱼ) is a distance metric. This may enable meaningful comparison of signals from sensors with different response times or sampling characteristics, which may be beneficial for multi-modal fusion where acoustic sensors might sample at 48 kHz while temperature sensors update at 1 Hz. The generality of the algorithm may allow alignment of any time series pairs regardless of their physical nature.

### Three-Dimensional Deployment Strategies

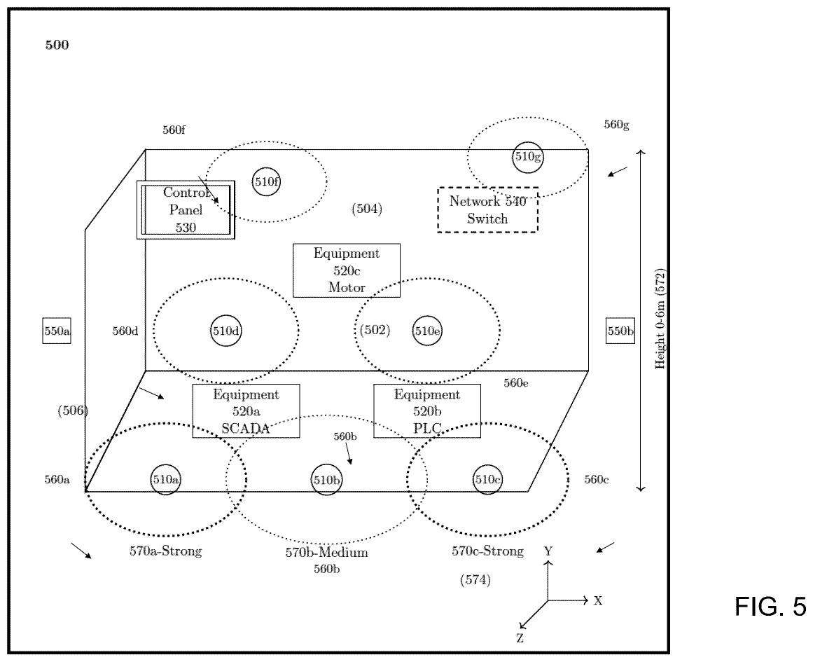

FIG. 5 illustrates a three-dimensional sensor deployment strategy 500 for monitoring a facility. The deployment strategy 500 may include sensor nodes 510 strategically positioned to monitor assets such equipment 520, control panels 530, network infrastructure 540, and facility perimeters 550. The coverage of the sensor nodes 510 may be represented as overlapping coverage volumes 560. The volumes 560 may ensure complete spatial monitoring without blind spots. Field strength indicators 570 may indicate the effective sensing ranges for different sensor modalities in the three-dimensional space. The deployment strategy 500 may include positioning the sensor nodes 510 at varying heights, depths, and orientations across walls, ceilings, floors, machinery housings, structural supports, and/or underground or overhead infrastructure.

The deployment strategy 500 may ensure comprehensive coverage of the monitored facility while optimizing cost and complexity. Unlike traditional security systems focusing on perimeter protection or critical point monitoring, this approach may create a volumetric sensing mesh capable of detecting anomalies anywhere within the protected space. The deployment strategy 500 may consider multiple factors including facility layout and equipment distribution, signal propagation characteristics for each sensor modality, required spatial resolution for anomaly localization, redundancy for critical areas, and/or installation and maintenance constraints. For example, the deployment strategy 500 may include a multi-tier sensing strategy, where different heights or depths are assigned to different sensor modalities or modality groups. For example, ceiling-mounted thermal sensors may be positioned for wide-area heat plume detection, mid-height vibration and acoustic sensors may be positioned for machinery fault detection, and floor-level gas and atmospheric composition sensors may be positioned to detect heavier-than-air gas leaks. The flexible deployment framework may accommodate any mix of sensor types based on facility-specific requirements.

Sensor placement optimization may employ computational techniques borrowed from wireless network planning and adapted for multi-modal sensing. The coverage volume 560 for each sensor may depend on its modality. For example, electromagnetic sensors may effectively monitor spheres that are 10 to 20 meters in radius, while vibration sensors may couple to specific structural elements with limited range. The optimization problem may seek to minimize the number of sensors while ensuring every point in the facility falls within effective range of multiple complementary sensor types:

$${min}_{{x}_{i}} {{\sum }_{i = 1}}^{N} {c}_{i} \cdot {x}_{i} subject to {{\sum }_{i = 1}}^{N} {a}_{ij} \cdot {x}_{i} \geq {r}_{j} ∀ j \qquad ( 14 )$$

where xᵢ indicates whether sensor i is deployed, cᵢ is its cost, aᵢⱼ represents coverage of location j by sensor i, and rⱼ is the required redundancy level. Genetic algorithms or integer programming solvers may find near-optimal solutions for realistic facility sizes. The optimization framework may handle heterogeneous sensor types with different coverage characteristics and costs.

Critical infrastructure may receive enhanced coverage with overlapping sensor fields ensuring no single point of failure. Control rooms housing SCADA systems may have at least 5 to 10 sensors providing diverse viewpoints, while less critical storage areas may have minimal coverage. The deployment strategy 500 may adapt to facility-specific requirements. For example, chemical plants may prioritize gas sensors for leak detection, while data centers may emphasize electromagnetic monitoring for information security. The deployment strategy 500 may ensure vertical coverage as well, with sensors positioned at multiple heights to detect anomalies at ground level, equipment height, and/or ceiling areas where unauthorized devices might be hidden.

The deployment strategy 500 may facilitate triangulation and source localization via multi-node time-difference-of-arrival (TDOA) measurements, received signal strength indicators (RSSI), and/or angle-of-arrival (AOA) calculations. Such methods may enable the determination of the origin of an anomalous event with high spatial accuracy.

The deployment strategy 500 may support dynamic deployment adaptation as threats evolve or facility layouts change. Mobile sensor nodes may be rapidly deployed to investigate specific concerns or provide temporary enhanced coverage during high-risk periods. The machine learning models may automatically adapt to topology changes, learning new spatial relationships and adjusting anomaly detection accordingly. The deployment strategy 500 may be adjusted dynamically based on real-time system feedback, such as identifying persistent blind spots or adjusting node density in high-risk zones. This flexibility may be beneficial in industrial settings where equipment configurations change frequently due to maintenance, upgrades, and/or production requirements. When new sensor types become available, they may integrate seamlessly into an existing deployment, with the monitoring system automatically learning their coverage characteristics and optimal placement strategies.

### Real-Time Anomaly Detection and Classification

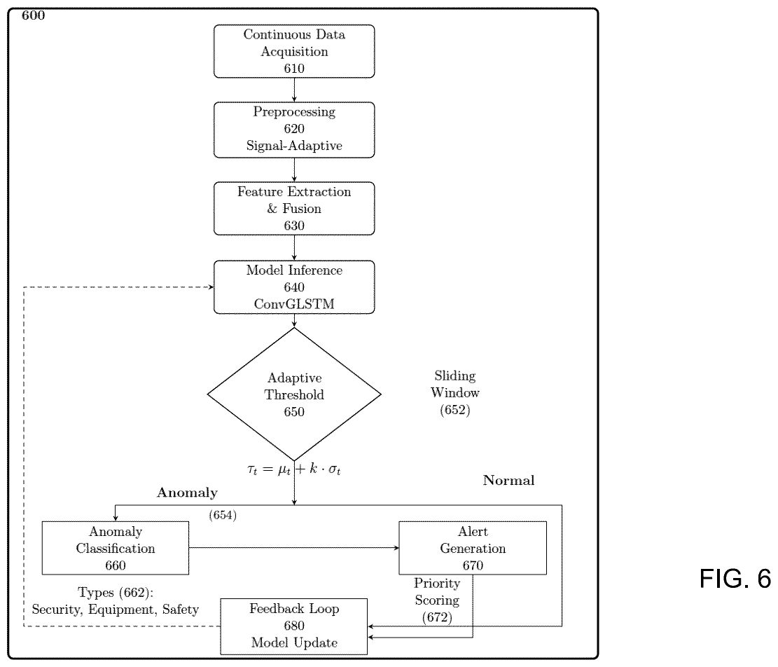

FIG. 6 illustrates a flowchart of a method 600 for adaptive monitoring of operational technology networks. While FIG. 6 shows illustrative operations according to one embodiment, other embodiments may omit, add to, reorder, and/or modify any of the operations shown in FIG. 6. Moreover, each of the operations depicted in FIG. 6 may be performed in any of the ways described herein. The operations shown in FIG. 6 may be performed by any of the illustrative systems described herein, such as the system 100.

The method 600 may include continuous real-time monitoring of assets. The real-time monitoring may include processing streaming sensor data through a trained ConvGLSTM model to detect anomalies with minimal latency. The method 600 may balance competing requirements for comprehensive analysis and rapid response through hierarchical processing where edge devices (e.g., the devices 120) perform preliminary screening while cloud resources (e.g., the analytics platform 130) execute sophisticated deep learning inference. This approach may enable sub-second detection of critical anomalies while maintaining the analytical depth necessary for subtle threat identification. The real-time processing pipeline may handle all sensor modalities through the same framework, with consistent latency and performance characteristics regardless of data type.

Operation 610 may include continuous data acquisition. A monitoring system may continuously acquire raw sensor data from various sensor nodes, such as the sensor nodes 110.

Operation 620 may include preprocessing steps. The preprocessing steps may include any of the preprocessing steps described herein, such as the preprocessing 430, the differencing 432, the detrending 434, and/or the seasonal adjustment 436.

Operation 630 may include feature extraction and fusion. The feature extraction and fusion may include any of the feature-related steps described herein, such as the feature extract 440, the lagged correlations 443, and/or the Granger causality analysis 444.

Operation 640 may include model inference using a ConvGLSTM model. The model may detect anomalies based on the extracted features. The model may implement a ConvGLSTM architecture, such as the architecture 300.

Operation 650 may include adaptive thresholding. Adaptive thresholding may include dynamically adjusting threshold parameters based on operational patterns. The adaptive thresholding may address the challenge that fixed thresholds inevitably generate excessive false positives as operational conditions evolve. The thresholding may maintain a sliding window of recent anomaly scores using the sliding window techniques 652, continuously updating threshold parameters based on statistical properties of this window. For a window of size W containing scores {s_{t-W+1}, . . . , sₜ}, the adaptive threshold is computed as:

$${τ}_{t} = {μ}_{t} + k \cdot {σ}_{t} \qquad ( 15 )$$

where μₜ and σₜ are the window mean and standard deviation, and k is a sensitivity parameter typically set between 3 and 6 based on required false positive rates. This approach may automatically adjust to gradual changes like seasonal variations or equipment aging while maintaining sensitivity to sudden anomalies. The adaptive mechanism may operate identically for anomaly scores derived from any sensor type or combination of modalities.

Operation 660 may include anomaly classification. The anomaly classification may include categorizing anomalies into distinct types 662, enabling appropriate response strategies. The types 662 may include several anomaly categories, such as:
security threats (e.g., unauthorized network access, abnormal wireless communications, patterns matching known attack signatures detected through electromagnetic and network sensors, etc.),
equipment malfunctions (e.g., mechanical failures, electrical faults, control system errors indicated by characteristic patterns in vibration, acoustic, and/or thermal data, etc.),
safety hazards (e.g., gas leaks, fire risks, structural issues requiring immediate intervention identified through chemical sensors and multi-modal correlation, etc.),
operational anomalies (e.g., authorized activities like maintenance operations or production changes, distinguished by contextual analysis across all modalities), and/or
environmental disturbances (e.g., external factors like severe weather, seismic activity, and/or electromagnetic interference affecting multiple sensors simultaneously).

Classification may leverage both the learned ConvGLSTM representations and rule-based logic incorporating domain expertise. For instance, simultaneous temperature and vibration increases at a motor may indicate bearing failure, while temperature increases with acoustic anomalies may suggest electrical arcing. The method 600 may maintain a knowledge base of anomaly signatures continuously updated through operational experience and expert feedback. The classification algorithms may process features from all sensor modalities uniformly, with the specific combination of active sensors determining the classification confidence.

Operation 670 may include alert generation. The alert generation may implement sophisticated prioritization using priority scoring 672, ensuring operators focus on the most critical issues.

The priority scoring 672 may include scoring and ranking detected anomalies based on prioritization factors, such as severity, risk potential, uncertainty, criticality, duration, rate of change, and/or time of day. For example, the priority scoring 672 may be calculated using:

$$P = {w}_{1} \cdot S + {w}_{2} \cdot C + {w}_{3} \cdot R + {w}_{4} \cdot U \qquad ( 16 )$$

where S is the anomaly severity (magnitude of deviation), C is the criticality of affected assets, R is the risk potential (safety/security implications), U is the uncertainty (inverse of model confidence), and we are weighting factors configured based on facility priorities. High-priority alerts may trigger immediate notifications through multiple channels including control room displays, mobile devices, and automated response systems. The prioritization system may process anomalies from all sensor types through the same framework, ensuring consistent treatment regardless of detection modality.

Operation 680 may include model updates using a feedback loop. The feedback loop may enable continuous model improvement through online learning. Operator responses to alerts (e.g., responses confirming true positives or marking false positives) may be incorporated into the training dataset. The model may periodically retrain on accumulated feedback, adapting to evolving operational patterns and emerging threat types. This lifelong learning approach may ensure the monitoring system remains effective despite changing conditions, new equipment installations, or evolving attack techniques. The feedback mechanism may handle all sensor modalities uniformly, improving detection accuracy across the entire multi-modal sensing array.

### Multi-Modal Sensor Fusion Architecture

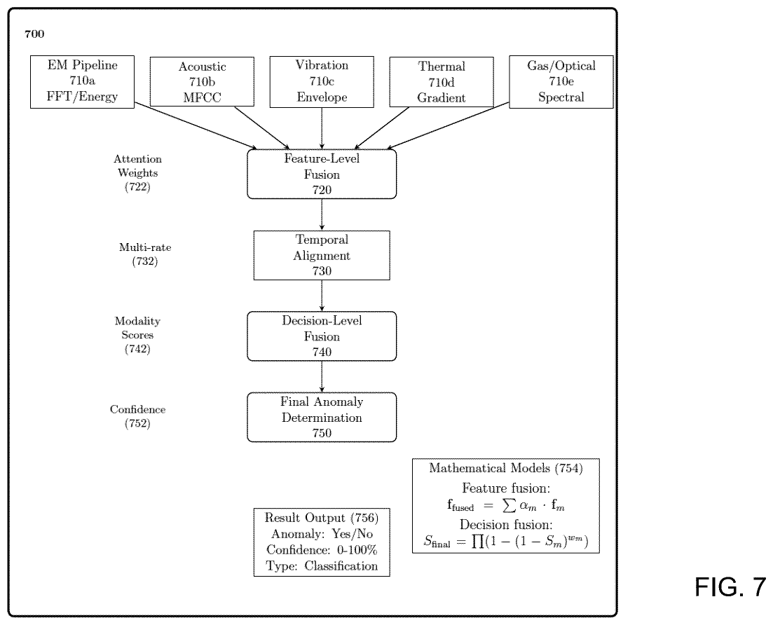

FIG. 7 illustrates a multi-modal sensor fusion architecture 700, showing parallel processing pipelines 710 for each sensor modality feeding into feature-level fusion 720 guided by learned attention weights 722. The architecture 700 may implement temporal alignment 730 to address challenges arising from different sampling rates 732 across modalities, implement decision-level fusion 740 combining modality-specific anomaly scores 742, and produce final anomaly determination 750 accompanied by quantified confidence metrics 752 supporting risk-aware operational decisions.

The architecture 700 may represent a sophisticated approach to combining diverse sensor information for robust anomaly detection. Rather than treating each sensor type independently, the architecture 700 may exploit complementary information across modalities to achieve detection capabilities exceeding any individual sensor. The fusion may occur at multiple levels (e.g., signal, feature, and decision), each level contributing unique advantages to the overall system performance. The generality of the architecture 700 may allow seamless integration of any sensor modality, with new sensor types easily incorporated through appropriate feature extraction modules.

Each pipeline 710 may handle the unique characteristics of each modality. Electromagnetic sensors may undergo spectral analysis using Fast Fourier Transforms (FFT) to identify frequency components, with particular attention to communication bands that might indicate unauthorized transmissions. For high-frequency signals beyond practical sampling rates, the pipelines 710 may employ energy detection and heterodyne techniques as previously described. Acoustic data processing may employ mel-frequency cepstral coefficients (MFCCs) and spectral centroid features proven effective in industrial sound analysis. Vibration signals may be analyzed using envelope analysis and spectral kurtosis to detect bearing faults and mechanical anomalies. Each pipeline 710 may output normalized feature vectors suitable for fusion while preserving modality-specific information. The modular design may allow easy addition of new sensor types by implementing appropriate feature extraction while reusing the fusion infrastructure.

The feature-level fusion 720 may combine extracted features from different modalities using the learned attention weights 722. The attention mechanism may adapt to different anomaly types. For example, optical and thermal sensors may receive highest weights for detecting unauthorized personnel, while equipment failure detection may prioritize vibration and acoustic data. The attention weights may be learned during training through backpropagation, automatically discovering optimal fusion strategies for different scenarios:

$${f}_{fused} = {{\sum }_{m = 1}}^{M} {α}_{m} \cdot {f}_{m} \qquad ( 17 )$$

where M is the number of modalities, αₘ are attention weights summing to 1, and fₘ are modality-specific feature vectors. This adaptive fusion may prove particularly powerful when certain sensors become temporarily unreliable due to environmental interference. The fusion mechanism may treat all modalities equally, learning their relative importance from data rather than hard-coded rules.

The feature-level fusion 720 may use hierarchical fusion, where the architecture 700 performs early fusion within related sensor modalities (e.g., all environmental sensors) and then late fusion across modality groups. This may allow for specialized processing for sensor modality groups.

The temporal alignment 730 may address the challenge of combining sensors with vastly different sampling rates 732. For example, while RF sensors may sample at 1 MHz to capture communication signals (or use specialized detection techniques for higher frequencies), temperature sensors may update at 1 Hz. The architecture 700 may employ multi-rate signal processing techniques including up-sampling with interpolation for slow sensors, down-sampling with anti-aliasing for fast sensors, and/or temporal buffering to align measurements. Sophisticated algorithms may preserve causality relationships ensuring that effect doesn't precede cause in the aligned data, which may be beneficial for accurate root cause analysis. The alignment algorithms may adapt automatically to the sampling characteristics of each modality.

The decision-level fusion 740 may combine anomaly determinations from individual modalities into final decisions. Each modality may generate its own anomaly score 742 based on deviation from learned normal patterns. These scores may be combined using:

$${S}_{final} = {{\prod }_{m = 1}}^{M} ( 1 - {( 1 - {S}_{m} )}^{{w}_{m}} ) \qquad ( 18 )$$

This formulation, based on Dempster-Shafer evidence theory, may allow any single modality to trigger an anomaly (logical OR behavior) while requiring multiple weak signals to combine into strong evidence. The weights wₘ may reflect reliability and relevance of each modality for specific anomaly types, learned from training data and continuously updated based on operational performance. The fusion framework may accommodate any number and type of sensor modalities without architectural changes.

The final anomaly determination 750 may incorporate the confidence metrics 752, which may quantify uncertainty in the detection. Uncertainty may arise from multiple sources including sensor noise and calibration errors, ambiguous patterns not clearly normal or anomalous, limited training data for rare scenarios, and/or conflicting evidence from different modalities. The architecture 700 may use ensemble methods and Bayesian approaches to quantify this uncertainty, enabling risk-aware decision making where high-confidence detections trigger automated responses while uncertain cases receive human review. The uncertainty quantification may apply uniformly across all sensor types and fusion configurations.

### Real-Time Visualization and Operator Interfaces

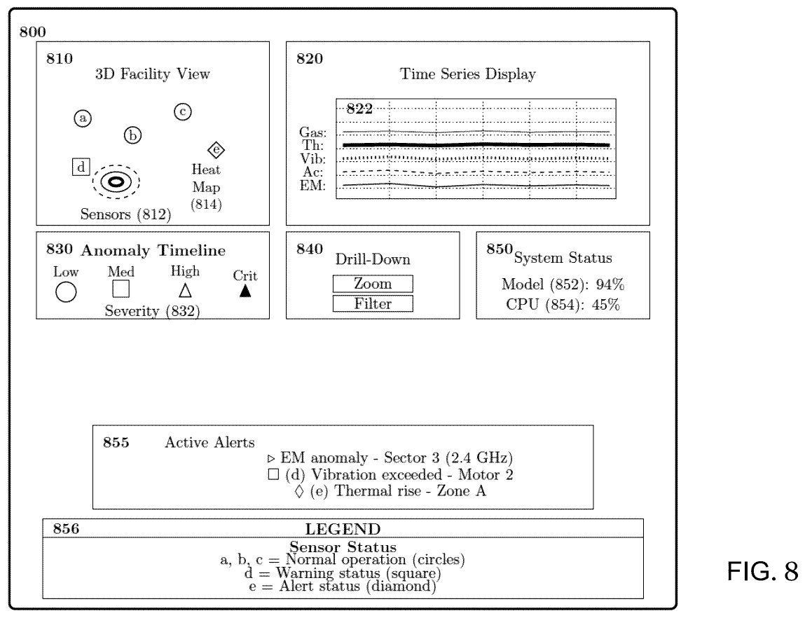

FIG. 8 illustrates a real-time monitoring interface 800. The interface 800 may include various representations of data derived from the monitoring system, such as sensor data, detected anomalies, and/or monitored assets. The interface 800 may be implemented as a graphical user interface (GUI), a web-based dashboard, a mobile application, an augmented reality (AR) display, and/or a virtual reality (VR) display.

As shown, the interface 800 may feature an interactive 3D facility visualization 810 with real-time sensor location indicators 812 and a dynamic anomaly heat map 814, time series displays 820 presenting multi-modal sensor data streams 822, a comprehensive anomaly timeline 830 with color-coded severity indicators 832, intuitive drill-down controls 840 for detailed anomaly investigation, and a system status panel 850 showing model confidence metrics 852 and computational resource utilization 854 for operational awareness.

The interface 800 may transform complex multi-dimensional sensor data into actionable intelligence for human operators. The design philosophy may emphasize situational awareness, enabling operators to quickly assess system status, identify emerging threats, and coordinate responses. The interface 800 may adapt to different user roles. For example, security personnel may focus on threat detection, maintenance staff may monitor equipment health, and managers may assess overall operational efficiency. The visualization framework may handle any combination of sensor modalities, automatically adjusting displays based on available data types.

The visualization 810 may include a spatial representation of the monitored environment. The indicators 812, representing sensor locations, may be icons colored by status, such as green for normal, yellow for warnings, and red for anomalies. The anomaly heat map 814 may interpolate between sensors to show threat probability throughout the facility, enabling operators to identify not just where sensors triggered but where threats likely originated or are heading. Real-time animation may show anomaly propagation, which may be beneficial for understanding cascade failures or coordinated attacks affecting multiple systems. The visualization 810 may automatically incorporate new sensor deployments and adapts to facility layout changes.

The time series displays 820 may show historical and real-time data from the data streams 822, enabling detailed investigation of anomalies. The interface 800 may support flexible time scales from microseconds for high-frequency phenomena to months for long-term trends. Multiple synchronization modes may allow viewing different sensors aligned by absolute time, relative to anomaly detection, or warped to show similar patterns despite temporal differences. Statistical overlays may show normal operating ranges, confidence intervals, and/or predicted values from the ConvGLSTM model. The displays 820 may handle diverse sampling rates across modalities, automatically interpolating or aggregating as needed for clear visualization.

The anomaly timeline 830 may provide a chronological view of all detected events with the severity indicators 832 using intuitive color coding and size scaling. The interface 800 may allow operators to filter by anomaly type, affected systems, and/or confidence levels to focus on specific concerns. Clustering algorithms may group related anomalies to identify coordinated attacks or system-wide failures versus isolated incidents. The timeline 830 may support forensic analysis by maintaining detailed logs of events, operator actions, and/or system responses. Multi-modal anomalies may be clearly indicated, showing which sensor types contributed to each detection.

The drill-down controls 840 may enable progressive disclosure of information, preventing operators from being overwhelmed while ensuring critical details remain accessible. Starting from high-level facility status, the controls 840 may allow operators to zoom into specific areas (e.g., selected assets, facility zones, operational areas, etc.), select individual sensors, examine raw data, view extracted features, analyze model internals, and/or access historical patterns. This hierarchical approach may support both rapid threat assessment and detailed investigation, adapting to the operator's immediate needs. The controls 840 may provide consistent navigation regardless of sensor types, with appropriate visualizations for each modality.

The system status panel 850 may provide critical operational metrics including the model confidence metrics 852 indicating how well current observations match training data and the computational resource utilization 854 ensuring the system operates within performance boundaries. Degraded confidence may indicate novel attack patterns requiring expert analysis, while high computational load may necessitate load balancing or capacity expansion. These meta-metrics may be beneficial for maintaining system reliability in production environments. The panel 850 may display sensor health statistics, communication link quality, and/or data transmission rates to or from edge and cloud processing systems.

The interface 800 may include representations that are customized for each sensor modality. For example, the interface 800 may include color temperature maps for thermal sensors, spectral decomposition plots for acoustic data, and/or 3D scatter plots for LIDAR point clouds.

The interface 800 may be implemented using an AR and/or VR system to enhance operator situational awareness in complex facilities. In an AR implementation, an operator wearing AR-enabled eyewear or using a mobile device with camera passthrough may view the actual physical environment (e.g., a facility) with real-time overlays of any components of the interface 800. The overlays may be superimposed directly onto the corresponding physical asset. The overlays may include directional arrows pointing toward anomaly sources and/or textual annotations displaying sensor readings or diagnostic summaries. In a VR implementation, the operator may navigate a fully immersive 3D model of the monitored facility, reconstructed from CAD models, LIDAR scans, and/or photogrammetry. The VR implementation may support multi-user collaboration, allowing geographically dispersed users to jointly investigate events in a shared virtual environment. The AR and VR implementations may improve rapid anomaly localization, facilitate remote collaboration, and reduce investigation time in critical security or safety incidents.

### Method for Real-Time Anomaly Detection and Classification

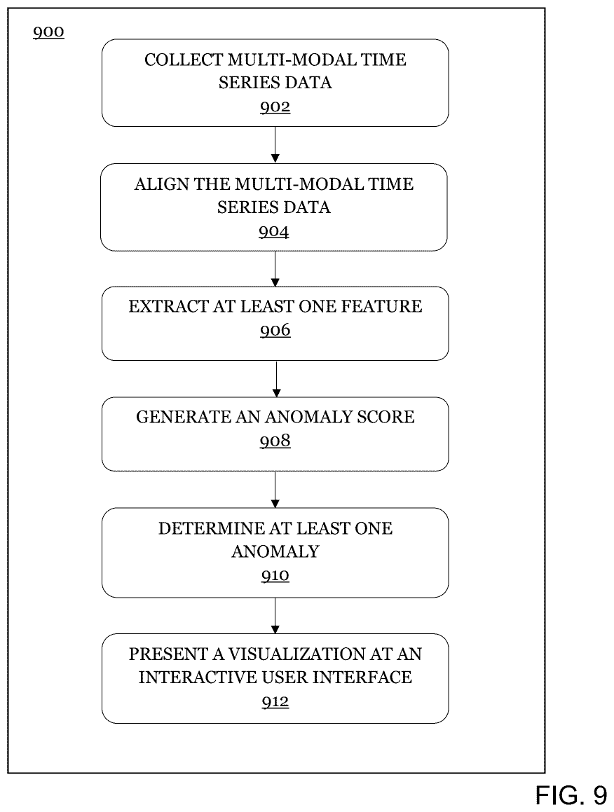

FIG. 9 illustrates a flowchart of a method 900 for adaptive monitoring of operational technology networks in accordance with one embodiment. While FIG. 9 shows illustrative operations according to one embodiment, other embodiments may omit, add to, reorder, and/or modify any of the operations shown in FIG. 9. Moreover, each of the operations depicted in FIG. 9 may be performed in any of the ways described herein. The operations shown in FIG. 9 may be performed by any of the illustrative systems described herein, such as the system 100.

Operation 902 may include collecting multi-modal time series data from a plurality of wireless sensor nodes. The sensor nodes may include multi-modal nodes, such as the sensor nodes 110. The sensor nodes may be deployed near at least one operational technology asset, such as the equipment 520, the control panels 530, the network infrastructure 540, and/or the facility perimeters 550. The operation 902 may be similar to the operation 610.

Operation 904 may include aligning the time series data using dynamic time warping. The operation 904 may be similar to the operation 620.

Operation 906 may include extracting at least one feature from the aligned time series data. The operation 906 may be similar to the operation 630.

Operation 908 may include generating, based on the extracted feature, an anomaly score using a trained machine learning model. The model may implement a ConvGLSTM architecture, such as the architecture 300. The operation 908 may be similar to the operation 640.

Operation 910 may include determining, based on the real-time anomaly score, at least one anomaly regarding the operational technology asset. The operation 910 may be similar to the operation 650 and/or operation 660.

Operation 912 may include presenting a visualization of the anomaly at an interactive user interface. The interface may be a real-time monitoring interface, such as the interface 800. The operation 912 may be similar to the operation 670.

### Manufacturing Facility Cybersecurity System

Embodiments include a comprehensive monitoring system optimized for manufacturing facilities with strict security requirements prohibiting unauthorized electronic devices. The system may deploy 50 to 100 multi-modal sensor nodes throughout a typical 50,000 square foot facility, with higher density around critical infrastructure including SCADA systems, PLCs controlling production lines, robotic work cells, and/or network equipment rooms. Each sensor node may contain electromagnetic field sensors covering 10 kHz to 6 GHz for detecting unauthorized wireless devices, acoustic sensors (covering 20 Hz to 6 kHz) for machinery monitoring, vibration sensors (covering 0.1 Hz to 10 kHz) for structural integrity, thermal imaging arrays for hot spot detection, and/or atmospheric composition sensors for safety monitoring. The sensor nodes may operate on rechargeable batteries providing 6 to 12 months of autonomous operation, with options for AC-DC power adapters in locations with available mains power or Power-over-Ethernet where network infrastructure permits.

The electromagnetic sensing capability may address the facility's mobile phone prohibition policy. During an initial training period, the system may learn baseline electromagnetic signatures including legitimate wireless devices (authorized tablets, RFID systems), background emissions from industrial equipment, and/or environmental RF noise patterns. For high-frequency signals such as 2.4 GHz WiFi or 5 GHz communications, the sensors may employ energy detection circuits and heterodyne down-conversion rather than impractical multi-GHz direct sampling. Controlled experiments may introduce phones at various locations to teach the system contextual interpretation. For example, brief cellular signals (e.g., 850 Mhz, 1900 Mhz bands) near employee entrances during shift changes may be logged as minor policy violations, while sustained cellular activity from production areas may trigger immediate security alerts. The system may distinguish between different threat levels, such as accidental policy violations, potential insider threats attempting data exfiltration, and/or sophisticated attacks using cellular networks for command and control.

A ConvGLSTM model trained on this facility data may achieve false positive rates below 0.05% while maintaining 98% true positive detection for genuine security threats. The model may learn complex patterns such as correlations between cellular signals and unusual network traffic indicating data exfiltration, movement patterns of unauthorized devices through the facility, and/or attempts to jam or spoof legitimate wireless systems. Real-time alerts may route to security personnel with precise localization (e.g., within 2 meters in accuracy), enabling rapid response to potential threats. The collected sensor data may be transmitted to edge computing devices for preliminary analysis and/or to cloud platforms for comprehensive ConvGLSTM processing, with automatic failover ensuring continuous operation even during network outages.

### Chemical Processing Plant Safety and Security System

Embodiments include a system that addresses the unique requirements of chemical processing facilities where safety hazards and security threats often manifest through subtle environmental changes. The system may deploy 100 to 200 sensor nodes in a typical refinery or chemical plant, with emphasis on multi-gas detection capabilities including H₂S, CO, CH₄, Cl₂, and/or VOCs. For example, gas and atmospheric composition sensors may be configured to detect hazardous gases, while thermal sensors may be configured to monitor for abnormal heat generation in reactors, pipelines, and/or electrical panels. Integration with existing distributed control systems (DCS) may provide comprehensive cyber-physical monitoring without disrupting critical process control loops. Sensor nodes in hazardous areas may utilize intrinsically safe designs with appropriate certifications, powered by specialized battery systems or explosion-proof AC-DC converters.

The signal processing pipeline may handle the extreme non-stationarity characteristic of chemical processes, where normal operations include startup/shutdown transients, grade changes, and/or seasonal variations. Advanced stationarity testing may identify signals requiring preprocessing reactor temperature profiles that require detrending to remove exothermic reaction signatures, while pressure signals require seasonal adjustment for ambient temperature effects. The system may learn to distinguish between normal process variations and anomalies indicative of equipment failure, cyber attacks on control systems, and/or safety hazards. The generalized algorithms may apply equally to all sensor modalities, processing chemical concentration data, pressure measurements, and/or flow rates through the same analytical framework.

The system may dynamically adjust operations based on the operational process phase of the chemical processing plant, including startup, steady-state, and shutdown phases. For example, the system may account for transient fluctuations in temperature, pressure, and flow rates that are characteristic of ramp-up operations (e.g., by relaxing anomaly thresholds). The system may tighten thresholds or correlation sensitivity during steady-state operations, and relax the thresholds or correlation sensitivity during shutdown phases.

The system may provide the integration of chemical signature analysis with cybersecurity monitoring. The system may detect coordinated attacks attempting to mask physical consequences. For example, a cyber attack modifying temperature setpoints while simultaneously suppressing alarms may be revealed through correlated changes in infrared signatures and trace gas emissions. The training period may capture various operating modes including normal production, maintenance turnarounds, and/or emergency shutdown procedures, ensuring comprehensive baseline establishment. Sensor data may stream to local edge servers for rapid safety response and/or to secure cloud infrastructure for advanced threat analysis.

### Data Center Infrastructure Monitoring System

Embodiments include a system that provides electromagnetic and thermal monitoring for data center environments, providing both security and operational efficiency. Dense sensor deployment (e.g., 200 to 500 nodes for a 10,000 square foot facility) may provide fine-grained environmental monitoring essential for detecting sophisticated attacks targeting specific servers or network equipment, environmental risks, or operational failures. Electromagnetic sensors may focus on higher frequencies (e.g., 1 MHz to 10 GHz) to detect covert channels, unauthorized wireless access points, and/or electromagnetic emanations potentially leaking sensitive information. For frequencies above practical sampling rates, the sensors may use spectrum analyzers with swept local oscillators and power detectors to characterize signal presence and strength without requiring GHz-rate digitization. Thermal sensors may monitor equipment inlet and exhaust temperatures, detect localized overheating, and track thermal stratification in server aisles. Gas and atmospheric composition sensors may detect harmful levels of particulates, volatile organic compounds, smoke, and/or gases that could indicate early signs of electrical fires or refrigerant leaks from HVAC systems. Acoustic sensors may capture changes in airflow noise patterns indicating fan degradation or blockage. Vibration sensors may detect abnormal mechanical operation in chillers, CRAC (Computer Room Air Conditioning) units, and/or uninterruptible power supply (UPS) systems.

The thermal monitoring capabilities of the system may include thermal imaging and gradient analysis. Normal data center operations may create complex thermal patterns with hot/cold aisle configurations, varying server loads, and/or HVAC cycling. A machine learning model may learn these patterns during a training period, subsequently detecting anomalies such as cryptocurrency mining malware (unusual sustained high CPU temperatures), failing cooling systems before critical thresholds, and/or unauthorized equipment generating unexpected heat signatures. Sensors may be powered through a combination of PoE for rack-mounted units and battery power for mobile deployment, with all data transmitted to redundant edge servers ensuring continuous monitoring even during power events.

The system may include specialized features for detecting sophisticated electromagnetic attacks. Side-channel analysis prevention may identify unusual electromagnetic emanations that may indicate attempts to extract cryptographic keys. The system may detect and localize sources of intentional electromagnetic interference (EMI) designed to disrupt operations. Correlation analysis between electromagnetic anomalies and network traffic patterns may reveal potential data exfiltration through covert channels. The distributed sensor network may provide spatial diversity, making it extremely difficult for attackers to evade detection. Real-time processing may occur at edge servers within the data center for sub-second response, with cloud analytics providing deeper threat intelligence and cross-facility correlation.

The system may be integrated with infrastructure management systems or software for the data centers. This integration may allow for automated hazard mitigation actions such as rerouting workloads away from affected servers or switching to backup power sources.

### Critical Infrastructure SCADA Protection System

Embodiments include a system that provides comprehensive monitoring tailored to SCADA and industrial control system environments, including electrical substations, water treatment facilities, and other critical infrastructure. Sensor placement may emphasize coverage of control rooms, relay houses, and/or remote terminal units (RTUs). The system may address unique challenges including outdoor deployment requiring weatherproof sensors rated for −40° C. to +85° C. operation, electromagnetic interference from high-voltage equipment requiring specialized shielding and filtering, and/or extended geographic distribution requiring long-range wireless connectivity using LoRaWAN or cellular backhaul.

The anomaly detection algorithms may specifically target known SCADA attack patterns while remaining adaptive to discover zero-day threats. Training data collection may be extended (e.g., to 4 to 6 weeks) to capture seasonal variations and different operational scenarios (e.g., peak load, maintenance modes, emergency responses, etc.). The system may learn to recognize normal SCADA communication patterns, legitimate remote access sessions, and/or authorized configuration changes. Deviations may trigger alerts with context, such as unusual commands during non-maintenance windows, communication from unauthorized IP addresses, and/or physical access attempts correlated with cyber anomalies receive highest priority. Sensor nodes may employ solar panels with battery backup for remote locations, while control room sensors may use redundant AC-DC power with automatic transfer.

Integration with existing SCADA historians and security information and event management (SIEM) systems may provide comprehensive visibility. The physical sensing capabilities of the system may complement traditional cybersecurity tools by detecting attacks that bypass network security, insider threats with physical access, and attempts to manipulate physical processes while spoofing SCADA displays. For example, an attack attempting to damage equipment by overriding safety interlocks may evade SCADA-level detection but may be revealed through abnormal vibration patterns, temperature increases, and/or electromagnetic signatures from stressed equipment. Data may flow through secure cellular or satellite links to regional processing centers, with edge analytics at substations providing autonomous response capability.

### Smart Building Integrated Security System

Embodiments include a system that adapts the technology for commercial buildings requiring both security and operational efficiency. The system may typically deploy 30 to 50 sensors per floor in modern office buildings, with concentration around server rooms, executive areas, and building automation systems. Multi-modal sensing may address diverse threats from unauthorized access to HVAC manipulation for biological attacks. A training period of 2 to 4 weeks may capture normal building patterns including occupancy variations, HVAC cycling, and/or legitimate wireless device usage by employees and visitors. Sensors may utilize building power through AC-DC adapters where available, with battery backup ensuring operation during power failures.

In buildings permitting mobile devices, the system may learn complex usage patterns distinguishing normal from anomalous behavior. Authorized phones typically remain stationary at desks, move predictably through common areas, and show characteristic usage patterns (brief activations for messaging, longer sessions during breaks). Anomalous patterns may include phones moving through restricted areas after hours, unusual data transmission patterns suggesting corporate espionage, and/or jamming signals attempting to disable security systems. The machine learning model may achieve this discrimination through spatiotemporal pattern analysis, which may include not just detecting phones but understanding their context within the building's operational patterns. The unified processing framework may handle all sensor types identically, such as WiFi signals, acoustic patterns from conversations, and/or thermal signatures from occupancy.

The system may provide value beyond security through operational insights. Correlation between occupancy patterns (e.g., detected through CO₂, thermal signatures, and wireless devices) and HVAC operation may enable energy optimization. Predictive maintenance capabilities may emerge from continuous monitoring and detecting of maintenance patterns, such as gradually increasing vibration in air handlers, slowly failing LED drivers detected through electromagnetic emissions, and/or degrading sensor performance indicating maintenance needs. This dual-use approach may justify deployment costs while providing comprehensive security coverage. Sensor data may transmit to building management systems for local control and/or to cloud platforms for advanced analytics and multi-building optimization.

### Transportation Hub Security Enhancement System

Embodiments include a system for addressing unique challenges of high-traffic public spaces with critical infrastructure, such as airports, train stations, and ports. Sensor deployment may follow a layered approach with perimeter monitoring, public area coverage, and/or intensive monitoring of control systems and restricted areas. The system may handle extreme variability in electromagnetic environments with many (e.g., thousands) passenger devices, communication systems, and industrial equipment creating complex baseline patterns. This may require extended training periods (e.g., more than 4 weeks) capturing different traffic patterns, seasonal variations, and/or special events. Sensors may employ diverse power strategies including tie-ins to existing security infrastructure, battery operation with weekly maintenance cycles, and/or energy harvesting from passenger foot traffic vibrations.

Advanced signal processing may handle the non-stationary nature of transportation hubs where normal characteristics change hourly. The system may employ adaptive windowing, such as shorter windows (e.g., 5 to 10 minutes) during peak periods for responsive detection and longer windows (e.g., 1 to 2 hours) during quiet periods for sensitivity to subtle anomalies. Multi-modal fusion may be beneficial as single modalities generate excessive false positives in such dynamic environments. For example, unusual electromagnetic signatures combined with abnormal acoustic patterns and thermal anomalies may provide high-confidence threat detection while filtering routine variations. The processing algorithms may apply uniformly to all sensor types, maintaining consistent performance regardless of whether the algorithms are analyzing RF emissions from passenger devices or chemical traces from explosive detection.

The system may specifically address transportation-specific threats including unauthorized drone detection through characteristic RF signatures (e.g., 2.4 GHz and 5.8 GHz control signals) and acoustic patterns, explosive device screening through trace chemical detection and thermal imaging, and/or cyber attacks on scheduling, ticketing, or control systems. Integration with existing security infrastructure (cameras, access control, screening equipment) may provide comprehensive situational awareness. For example, the system may integrate with public address systems, passenger information displays, and/or emergency lighting to provide real-time alerts or instructions to the public. Real-time 3D visualization may enable security personnel to track threats through complex multi-level facilities, with predictive analytics suggesting likely threat trajectories based on historical patterns. Distributed edge processing at security checkpoints may enable rapid response, while centralized cloud analytics may correlate threats across the entire facility and between multiple transportation hubs.

### Method for Initial System Deployment and Configuration

Embodiments include a method for deploying the adaptive monitoring system in operational technology environments, beginning with systematic site assessment and sensor placement optimization. The method may be performed by any of the systems described herein, such as the system 100.

The initial deployment phase may include facility analysis including 3D mapping of the physical environment, identification of critical assets requiring enhanced monitoring, electromagnetic site survey to characterize background emissions across the full DC to GHz spectrum, network topology documentation for IT/OT integration, and/or safety hazard assessment for sensor placement constraints. This analysis may employ automated tools (e.g., 3D laser scanning, spectrum analyzers) and/or expert evaluation to create a comprehensive deployment plan.

Sensor placement optimization may use computational algorithms balancing coverage, redundancy, and/or cost. The method may employ integer programming formulations:

$$min {{\sum }_{i = 1}}^{N} {c}_{i} {x}_{i} subject to {{\sum }_{i = 1}}^{N} {a}_{ij} {x}_{i} \geq {r}_{j} ∀ j ∈ CriticalPoints \qquad ( 19 )$$

where xᵢ indicates whether sensor location i is selected, cᵢ represents deployment cost, aᵢⱼ indicates coverage of critical point j by sensor i, and rⱼ specifies required redundancy level. Genetic algorithms may solve this optimization for facilities with hundreds of potential sensor locations, generating deployment plans that ensure every critical asset falls within effective range of multiple complementary sensor types while minimizing total system cost.

Physical installation may follow strict protocols ensuring reliable operation and minimal disruption to existing operations. Sensor nodes may be mounted using non-invasive methods (magnetic bases, adhesive mounts, straps) avoiding drilling or welding near critical equipment. Power provisioning may employ a combination of battery operation with a 6 to 12 month lifetime for remote locations, AC-DC power adapters for permanent installations with available main power, Power-over-Ethernet where network infrastructure permits, and/or energy harvesting from vibrations, thermal gradients, or indoor solar cells for supplementary power. Wireless network configuration may implement secure mesh topologies with automatic routing around failures, encryption using AES-256 with perfect forward secrecy, and/or authentication via certificates preventing unauthorized nodes. Data transmission paths may be configured to support local edge processing, cloud analytics, and/or hybrid architectures based on latency requirements and available bandwidth.

Initial configuration may establish baseline operational parameters through automated calibration routines compensating for installation variations, time synchronization achieving less than 1 ms accuracy across all nodes using IEEE 1588 PTP, and/or preliminary threshold setting based on ambient conditions. The method may include validation testing confirming sensor operation across all modalities, network connectivity to edge and cloud platforms, and/or data flow verification before proceeding to the training phase. For electromagnetic sensors detecting high-frequency signals, calibration may include verification of energy detectors, mixer local oscillators, and/or spectrum analyzer sweep rates to ensure accurate characterization of signals from DC to several GHz without requiring impractical sampling rates.

### Method for Comprehensive Training Data Collection

Embodiments may include a method with a training period for capturing the full spectrum of normal operational patterns. The method may be performed by any of the systems described herein, such as the system 100.

The method may specify minimum training durations based on facility type, such as 2 to 3 weeks for static environments (e.g., data centers, office buildings, etc.), 3 to 4 weeks for manufacturing facilities with regular production cycles, 4 to 6 weeks for chemical plants with longer process cycles, and/or seasonal extensions for facilities with weather-dependent operations. During this period, sensor data from all modalities may stream continuously to edge devices for preprocessing and/or to cloud platforms for comprehensive analysis and model training.

During training, a monitoring system may operate in learning mode with all anomaly detection disabled to prevent false positives from incomplete baselines. Facility operators may maintain detailed logs documenting all significant events including production changes, maintenance activities, equipment startups/shutdowns, environmental conditions, and/or any unusual but authorized activities. This contextual information may be beneficial for interpreting learned patterns and setting appropriate thresholds for different operational modes. The training algorithms may process all sensor modalities through the same framework, automatically adapting feature extraction and normalization to each data type while maintaining consistent anomaly detection performance.

The method may employ active learning strategies to ensure comprehensive coverage of the operational state space. Gap analysis may identify regions of the feature space with insufficient training data, prompting operators to execute specific scenarios. For example, if emergency shutdown procedures have not occurred during passive training, controlled tests may ensure the system learns these critical patterns. Synthetic data augmentation may generate variations of observed patterns, expanding training sets to include plausible but unobserved scenarios. For example, if temperature sensors show ±5° C. daily variations, augmentation may create training data with ±7° C. variations providing robustness against seasonal changes. This augmentation may apply to all sensor types, creating synthetic electromagnetic interference patterns, acoustic variations, and/or chemical concentration fluctuations.

For facilities with mobile device policies, the training period may include controlled experiments establishing contextual interpretation capabilities. In restricted environments, security personnel may introduce phones at various locations and times while logging circumstances. The system may learn that brief cellular detections near entrances during shift changes likely represent policy oversights, sustained signals from production areas indicate serious violations, and/or coordinated patterns across multiple sensors suggest deliberate security breaches. For high-frequency signals like 2.4 GHz WiFi or 5 GHz communications, the training period may ensure proper characterization using the specialized detection circuits rather than direct sampling. This contextual training may dramatically reduce false positives while maintaining security effectiveness across all electromagnetic frequencies of interest.

Training validation may employ cross-validation on collected data and shadow-mode operation where the system generates predictions compared against expert annotations. Metrics tracked may include true positive rates (e.g., with a target greater than 95%), false positive rates (e.g., with a requirement less than 0.1%), precision and recall balances, and/or computational performance for both edge and cloud processing. The method may require achieving all performance targets before transitioning to operational deployment, with extended training if necessary. The validation process may confirm consistent performance across all sensor modalities and data transmission architectures.

### Method for Real-Time Anomaly Detection and Response

Embodiments include a method for real-time anomaly detection and response. The method may be performed by any of the systems described herein, such as the system 100.

In operational mode, the method may orchestrate continuous monitoring, analysis, and response to detected anomalies. Real-time data may stream from distributed sensors to edge devices for immediate preprocessing and preliminary anomaly detection, then to cloud platforms for sophisticated ConvGLSTM analysis. Critical anomaly detection for safety and security events may complete within 100 to 500 ms at the edge, while comprehensive multi-modal analysis in the cloud may provide deeper insights within 1 to 5 seconds. The hierarchical processing architecture may balance rapid response with analytical depth, automatically routing data based on criticality and available network resources.

The adaptive thresholding method may maintain consistent false positive rates despite evolving operational conditions. For each sensor channel and derived feature, a monitoring system may maintain sliding windows of recent anomaly scores:

$${τ}_{t} = {μ}_{t} + k \cdot {σ}_{t} \qquad ( 20 )$$

where window statistics update continuously and sensitivity parameter k adjusts based on operational context (e.g., lower during maintenance periods, higher during critical operations). This adaptive approach may eliminate the need for manual threshold adjustments that plague traditional systems, automatically accommodating gradual changes like equipment aging while maintaining sensitivity to sudden anomalies. The thresholding may apply uniformly to all sensor modalities, from slowly varying temperature data to rapidly changing electromagnetic signatures.

Upon anomaly detection, the method may implement a sophisticated decision tree considering anomaly severity, affected assets, correlation with other sensors, and/or operational context. High-confidence security threats (e.g., electromagnetic anomalies correlated with network intrusions) may trigger immediate automated responses, such as isolation of affected network segments, lockdown of physical access points, and/or activation of incident response teams. Lower confidence anomalies or those requiring human interpretation may generate prioritized alerts with rich context, such as 3D visualization of anomaly location and propagation, time-synchronized data from all relevant sensors, historical patterns for comparison, and/or suggested investigation steps. Processing the method may occur at edge devices, in the cloud, and/or through hybrid architectures.

The method may include provisions for managing alert fatigue through intelligent clustering and suppression. Related anomalies (e.g., when multiple sensors detect the same root cause) may cluster into single incidents, preventing operators from being overwhelmed by redundant alerts. Adaptive suppression may prevent repeated notifications for persistent but acknowledged issues, while ensuring new or escalating problems receive appropriate attention. Machine learning models may learn from operator responses, gradually improving alert relevance and priority assignment. This learning may occur through secure channels regardless of whether operators interact with edge-based interfaces or cloud-hosted dashboards.

### Method for Multi-Modal Sensor Fusion and Interpretation

Embodiments include a sensor fusion method for addressing the challenge of combining diverse data streams with different physical characteristics, sampling rates, and/or reliability levels into coherent anomaly determinations. The method may be performed by any of the systems described herein, such as the system 100.

The method may use a hierarchical fusion approach that operate at three levels, each contributing unique capabilities to the overall system performance. The method may apply identically to all sensor combinations, such as electromagnetic and acoustic data, thermal and vibration signals, and/or any other modality pairing.

Signal-level fusion may align and combine raw sensor data, addressing temporal misalignment through dynamic time warping and sample rate disparities through multi-rate signal processing. For example, combining electromagnetic signals potentially containing GHz-frequency components (e.g., detected through energy detection and heterodyning) with 1 Hz temperature updates may require sophisticated buffering and interpolation schemes preserving causality, as temperature changes cannot appear to predict RF events that actually caused them. The method may employ Kalman filtering for optimal state estimation when sensor measurements have different noise characteristics and update rates.

Feature-level fusion may combine extracted features using attention mechanisms that adapt to different anomaly types:

$${f}_{fused} = {{\sum }_{m = 1}}^{M} {α}_{m} ( t , c ) \cdot {f}_{m} \qquad ( 21 )$$

where attention weights am depend on time t and context c. During normal operations, all modalities may contribute equally. When detecting unauthorized wireless devices, electromagnetic sensors may receive higher weights. For mechanical failures, vibration and acoustic sensors may receive higher weights. This adaptive weighting, learned during training and continuously refined during operation, may dramatically improve detection accuracy compared to fixed fusion schemes. The fusion may occur at edge devices for rapid local decisions and/or in cloud platforms for comprehensive analysis.

Decision-level fusion may combine individual modality determinations using evidence theory frameworks:

$${S}_{final} = {{\prod }_{m = 1}}^{M} ( 1 - {( 1 - {S}_{m} )}^{{w}_{m}} ) \qquad ( 22 )$$

This formulation may allow any single modality to trigger an anomaly (e.g., as a logical OR) while requiring multiple weak signals to combine into strong evidence. Reliability weights wₘ may reflect historical performance of each modality for specific anomaly types, updated through Bayesian learning as operational experience accumulates. The method may include provisions for handling sensor failures. For example, when a modality becomes unavailable, fusion weights may redistribute to maintain detection capability with acceptable degradation. The decision fusion process may operate consistently regardless of whether data processing occurs locally, remotely, and/or in distributed fashion.

### Method for System Adaptation and Continuous Improvement

Embodiments may include a method for maintaining and improving system performance throughout its operational lifetime. The method may be performed by any of the systems described herein, such as the system 100.

Unlike static security systems that degrade as threats evolve, the method may implement continuous learning from operational experience while maintaining stable false positive rates. This adaptation process may operate on data collected from all sensor modalities and processed through edge devices, cloud platforms, and/or hybrid architectures.

Online learning may incorporate validated anomalies and false positives into the training dataset through experience replay mechanisms, which may prevent catastrophic forgetting, incremental model updates without full retraining, and/or careful balance between plasticity and stability. When operators confirm true anomalies, a monitoring system may extract feature patterns and update its threat library. When false positives are marked, the system may adjust decision boundaries reducing future occurrences. This lifelong learning approach may achieve noticeable improvement in detection accuracy over operational periods. The learning process may handle high-frequency electromagnetic detections (characterized through specialized circuits) as effectively as low-frequency temperature variations.

The method may address concept drift, which refers to gradual changes in normal operational patterns through multiple mechanisms. Sliding window baselines may track recent statistics while maintaining longer historical context. Ensemble models may combine predictions from models trained on different time periods, automatically weighting recent models higher when drift is detected. Change point detection algorithms may identify sudden shifts requiring rapid adaptation, such as installation of new equipment or modification of operational procedures. These mechanisms may apply uniformly across all sensor types and processing architectures.

Performance monitoring and optimization may occur continuously through automated metrics collection and analysis. The system may track true/false positive/negative rates by anomaly type and sensor modality, detection latency and computational load at edge and cloud tiers, sensor reliability and failure patterns across different power configurations, and/or operator response times and actions. Machine learning algorithms may analyze these metrics to identify improvement opportunities, such as sensors requiring recalibration or replacement, anomaly types with poor detection rates needing algorithm refinement, and/or operational procedures causing excessive false positives requiring training updates.

The method may include provisions for system expansion and reconfiguration as facilities evolve. New sensor nodes may automatically integrate into the existing network through secure provisioning protocols, with the machine learning models adapting to expanded coverage without full retraining. When equipment is modified or relocated, the system may detect topology changes and update spatial models accordingly. This flexibility may ensure the security system remains effective despite continuous facility evolution typical in industrial environments. New sensor modalities may integrate seamlessly, with the system automatically learning their characteristics and optimal fusion strategies.

### Method for Forensic Analysis and Incident Investigation

Embodiments include a method for providing comprehensive forensic capabilities. The method may be performed by any of the systems described herein, such as the system 100.

The method may enable detailed post-event analysis when security incidents occur. Any relevant data such as sensor data, event metadata, operator actions, detected anomalies, and/or system alerts may undergo lossless compression and encrypted storage with configurable retention periods (e.g., 30 to 90 days of full resolution data and 1 to 2 years of statistical summaries). Cryptographic timestamps and chain-of-custody mechanisms may ensure data integrity for potential legal proceedings. The storage architecture may support distributed retention across edge devices and cloud platforms, with automatic replication ensuring data availability.

The method may employ sophisticated visualization and query tools enabling investigators to reconstruct events from multiple perspectives. Time-synchronized playback may show the evolution of sensor readings before, during, and after incidents. Spatial visualization may reveal attack propagation through facilities. Statistical analysis may identify subtle precursors that might indicate advanced persistent threats. Machine learning algorithms may automatically identify similar patterns in historical data, potentially revealing previously undetected incidents or attack reconnaissance. The analysis tools may handle all sensor modalities uniformly, whether examining electromagnetic signatures of data exfiltration or thermal patterns indicating equipment sabotage.

Correlation with external data sources may enhance forensic capabilities. The method may employ interfaces for incorporating SIEM logs, network packet captures, physical access records, and/or production system data. Temporal alignment algorithms may synchronize these diverse sources despite clock skew and different timestamp formats. Graph analytics may reveal relationships between seemingly unrelated events. For example, unauthorized wireless device detection (even at GHz frequencies detected through specialized circuits) may be linked with unusual network traffic and subsequent equipment malfunctions indicating a coordinated cyber-physical attack.

The method may generate comprehensive incident reports combining automated analysis with investigator annotations. Reports may include executive summaries with impact assessment, detailed technical analysis with supporting data from all sensor modalities, visual reconstructions of the incident showing spatiotemporal evolution, root cause analysis with confidence levels, and/or recommendations for preventing recurrence. Machine learning models trained on accumulated incident data may suggest investigation priorities and identify patterns across multiple incidents indicating persistent threats or systemic vulnerabilities. The forensic process may operate regardless of whether data resides on edge devices, cloud platforms, and/or is distributed across both.

### INDUSTRIAL APPLICABILITY

The systems described herein may address critical and growing needs in operational technology security across multiple industrial sectors. The combination of comprehensive environmental sensing, sophisticated signal processing for industrial environments, and machine learning optimized for minimal false positives may allow the systems to be beneficial in a variety of industrial applications.

Manufacturing industries may represent a primary market for anomaly monitoring. Examples of relevant manufacturing industries may include semiconductors, electronics, pharmaceuticals, biotechnology, medical devices, chemical processing, automotive parts, and aerospace parts. The systems may address specific manufacturing needs including protection of intellectual property and trade secrets, detection of insider threats and industrial espionage, compliance with industry regulations and cyber insurance requirements, and/or integration with existing manufacturing execution systems (MES). For example, pharmaceutical and biotechnology industries often rely on extensive intellectual property portfolios to protect sensitive and rapidly developing information such as proprietary drug formulations, cell line development processes, and biomanufacturing recipes. They also face heavy regulation, which may require sufficient security safeguards for facilities. The ability of the systems to detect both cyber and physical anomalies may provide comprehensive protection unavailable from traditional solutions. The flexible deployment architecture supporting edge processing, cloud analytics, and/or hybrid approaches may accommodate diverse IT infrastructure maturity levels across manufacturing sectors.

Applicable infrastructure sectors including energy, water, transportation, and telecommunications may face regulatory mandates for improved security. The systems may enable compliance with standards such as NERC CIP for electrical utilities, TSA Security Directives for pipelines, and/or emerging regulations for water treatment facilities. Unlike compliance-focused solutions that merely meet minimum requirements, the systems may provide genuine security improvements while automatically generating documentation required for regulatory audits. The ability to detect zero-day attacks and novel threat vectors may position facilities to exceed compliance requirements and achieve true security resilience. The capability to detect high-frequency electromagnetic threats without requiring impractical GHz sampling rates may prove particularly beneficial for infrastructure monitoring.

The scalable architecture of the systems may support diverse deployment models from small industrial facilities to large, distributed infrastructure. Entry-level configurations with 20 to 30 sensors may address small manufacturing plants or electrical substations at price points under $100000. Enterprise deployments with hundreds of sensors and advanced analytics capabilities may scale to $1 to 5 million for major industrial complexes. Managed security service providers (MSSPs) may offer monitoring-as-a-service using the cloud-based architecture, making advanced capabilities accessible to smaller organizations through operational expense models. The ability to process data at edge devices, in the cloud, and/or through hybrid architectures may provide deployment flexibility matching diverse customer requirements.

Manufacturing considerations may leverage existing IoT and industrial electronics supply chains. System components including MEMS sensors, wireless communication modules, and embedded processors may be readily available from multiple suppliers, ensuring supply chain resilience. The modular sensor design may enable efficient manufacturing with automated assembly for standard configurations and manual customization for specialized requirements. Quality control processes adapted from industrial IoT manufacturing may ensure reliability in harsh industrial environments. Production scaling from prototype quantities to thousands of units annually may require minimal capital investment. The universal signal processing algorithms applying to all sensor modalities may simplify software development and validation.

The competitive advantages of the systems may stem from fundamental technical innovations rather than incremental improvements. The multi-modal sensing approach may provide visibility unavailable from network-only solutions. Advanced signal processing handling non-stationary industrial signals may reduce false positives by an order of magnitude compared to existing systems. The ConvGLSTM architecture may detect sophisticated attacks that evade signature and rule-based approaches. Continuous learning capabilities may ensure the systems improve over time rather than becoming obsolete as threats evolve. The ability to characterize electromagnetic threats across the full DC to GHz spectrum without requiring extreme sampling rates may provide unique capabilities for detecting modern wireless threats.

The systems may have various economic benefits. For example, prevented incidents may allow business to avoid economics losses. Reduced false positives may reduce operator hours. Improved equipment reliability through early anomaly detection may reduce maintenance costs. Cyber insurance premium reductions for facilities with advanced monitoring may offset operational costs. Compliance automation may reduce audit preparation time, thus freeing up resources for productive activities. Energy optimization through occupancy and equipment monitoring may reduce utility costs.

The systems may have various social benefits that extend beyond individual facility protection to broader infrastructure resilience. Critical infrastructure protection may ensure continued delivery of essential services including electricity, water, and transportation. Environmental monitoring capabilities may enable early detection of hazardous releases protecting communities and ecosystems. Job creation in deployment, monitoring, and analysis services may provide high-skill employment opportunities. Technology transfer to adjacent fields such as smart cities and environmental monitoring may amplify societal impact.

What is claimed is:

1. A computer-implemented method for adaptive monitoring of an operational technology network, comprising:
collecting multi-modal time series data from a plurality of wireless sensor nodes deployed near at least one operational technology asset;
aligning the time series data using dynamic time warping;
extracting at least one feature from the aligned time series data;
generating, based on the extracted feature, a real-time anomaly score using a trained machine learning model;
determining, based on the real-time anomaly score, at least one anomaly regarding the operational technology asset; and
presenting a visualization of the anomaly at an interactive user interface.

2. The computer-implemented method of claim 1, wherein the operational technology asset comprises at least one of a manufacturing facility, an industrial control system, a data center, or a chemical plant.

3. The computer-implemented method of claim 1, wherein the wireless sensor nodes comprise a plurality of sensing modalities, the modalities comprising at least two of an electromagnetic field sensor, an acoustic sensor, an accelerometer, an optical sensor, a thermal sensor, a gas and atmospheric sensor, or a radio frequency sensor.

4. The computer-implemented method of claim 1, wherein the wireless sensor nodes are deployed using a three-dimensional deployment strategy to provide maximum coverage for monitoring the operational technology asset.

5. The computer-implemented method of claim 1, wherein the aligning of the time series data comprises minimizing a total distance along a warping path.

6. The computer-implemented method of claim 1, further comprising:
determining whether the time series data comprises stationary data using an Augmented Dickey-Fuller test; and
performing at least one preprocessing task on the time series data based on the determination, the preprocessing task including at least one of conditional preprocessing, differencing, detrending, seasonal adjustment, lagged correlation analysis, Granger causality analysis, or signal alignment.

7. The computer-implemented method of claim 6, wherein the processing task includes at least one of the differencing, the detrending, or the seasonal adjustment based on the determination indicating that the time series data comprises non-stationary data.

8. The computer-implemented method of claim 1, wherein the machine learning model comprises a ConvGLSTM neural network trained using historical time series data collected under normal operating conditions.

9. The computer-implemented method of claim 8, wherein the neural network comprises an input layer, at least one graph convolutional layer fed by the input layer, at least one LSTM layer fed by the graph convolutional layer, and an output layer fed by the LSTM layer.

10. The computer-implemented method of claim 1, wherein the machine learning model is trained to capture spatial and temporal dependencies from input data.

11. The computer-implemented method of claim 1, wherein the visualization of the anomaly comprises an interactive 3D model of the operational technology asset.

12. The computer-implemented method of claim 1, further comprising presenting, at the interactive user interface based on the anomaly, at least one of an anomaly heat map, a drill-down control, a time series display presenting the time series data, or an anomaly timeline.

13. The computer-implemented method of claim 1, further comprising fusing at least one of the time series data with additional time series data, the extracted feature with additional features, or the real-time anomaly score with additional anomaly scores.

14. The computer-implemented method of claim 1, wherein the determining of the anomaly comprises comparing the anomaly score to an adaptive threshold value using a sliding window.

15. A system for adaptive monitoring of operational technology networks, comprising:
a plurality of wireless sensor nodes for collecting multi-modal time series data, the sensor nodes deployed near at least one operational technology asset;
memory storing instructions; and
at least one processor executing the instructions to perform the steps of:
aligning the time series data using dynamic time warping;
extracting at least one feature from the aligned time series data;
generating, based on the extracted feature, a real-time anomaly score using a trained machine learning model;
determining, based on the real-time anomaly score, at least one anomaly regarding the operational technology asset; and
presenting a visualization of the anomaly at an interactive user interface.

16. The system of claim 15, wherein the operational technology asset comprises at least one of a manufacturing facility, an industrial control system, a data center, or a chemical plant.

17. The system of claim 15, wherein the wireless sensor nodes comprise a plurality of sensing modalities, the modalities comprising at least two of an electromagnetic field sensor, an acoustic sensor, an accelerometer, an optical sensor, a thermal sensor, a gas and atmospheric sensor, or a radio frequency sensor.

18. The system of claim 15, wherein the machine learning model comprises a ConvGLSTM neural network trained using historical time series data collected under normal operating conditions.

19. The system of claim 15, wherein the visualization of the anomaly comprises an interactive 3D model of the operational technology asset.

20. A computer program product embodied in a non-transitory computer readable storage medium and comprising computer instructions for:
collecting multi-modal time series data from a plurality of wireless sensor nodes deployed near at least one operational technology asset;
aligning the time series data using dynamic time warping;
extracting at least one feature from the aligned time series data;
generating, based on the extracted feature, a real-time anomaly score using a trained machine learning model;
determining, based on the real-time anomaly score, at least one anomaly regarding the operational technology asset; and
presenting a visualization of the anomaly at an interactive user interface.
